(19) United States
(12) Patent Application Publication
(10) Pub. No.: US 2026/0067686 A1
(43) Pub. Date: Mar. 5, 2026

(54) COMMUNICATION APPARATUS, CONTROL METHOD THEREOF, AND STORAGE MEDIUM STORING PROGRAM

(71) Applicant: CANON KABUSHIKI KAISHA, Tokyo (JP)

(72) Inventor: KEI TAKARABE, Kanagawa (JP)

(21) Appl. No.: 19/298,333

(22) Filed: Aug. 13, 2025

(30) Foreign Application Priority Data
Aug. 29, 2024 (JP) 2024-147847

(51) Int. Cl. H04W 12/06; H04W 4/80; H04W 76/10; H04W 84/12

(52) U.S. Cl. CPC H04W 12/06; H04W 4/80; H04W 76/10; H04W 84/12

(57) ABSTRACT

A communication apparatus includes: a selection unit that selects, from a plurality of methods, a method for the communication apparatus and the external apparatus to share a parameter used by the communication apparatus and the external apparatus to connect through the wireless communication, in accordance with a user operation; and a control unit that controls processing for sharing the parameter between the communication apparatus and the external apparatus to be executed using the method selected by the selection unit. The control unit controls mutual authentication to be performed between the communication apparatus and the external apparatus after the processing for sharing the parameter using the method selected by the selection unit is performed.

### BACKGROUND

### Field of the Technology

The present disclosure relates to a communication apparatus, a control method thereof, and a storage medium storing program.

### Description of the Related Art

With the increase in the amount of data communicated in recent years, the development of communication technologies such as wireless Local Area Network (LAN) and the like is moving forward. The Institute of Electrical and Electronic Engineers (IEEE) 802.11 standard series is known as a major wireless LAN communication standard. The IEEE 802.11 standard series includes IEEE 802.11a/b/g/n/ac/ax standards and the like. For example, IEEE 802.11ax, which is the newest standard, uses Orthogonal Frequency Division Multiple Access (OFDMA) to standardize a technique for providing high peak throughput of up to 9.6 gigabits per second (Gbps) and improving communication speeds under congested conditions. “OFDMA” is an acronym for “Orthogonal Frequency-Division Multiple Access”.

Meanwhile, the Wi-Fi Alliance has formulated programs for authenticating wireless LAN devices. For example, the WFD standard has been formulated, which specifies procedures for exchanging (sharing) communication parameters among wireless LAN stations (STAs) to establish communication links between the STAs without going through an access point (AP). WFD is an acronym for “Wi-Fi Direct” (registered trademark).

The Wi-Fi Aware standard, which is a standard for searching for services provided by devices, has also been formulated. For example, Japanese Patent Laid-Open No. 2019-201427 describes detecting a communication terminal using the provisions set forth by the Wi-Fi Aware standard. Furthermore, Japanese Patent Laid-Open No. 2019-180036 discloses sharing parameters by reading a QR code (registered trademark) containing connection information in order to establish a wireless infrastructure connection.

### SUMMARY

The present disclosure provides a system for enabling an appropriate parameter sharing method to be selected according to an environment of a communication apparatus.

The present disclosure in one aspect provides a communication apparatus a communication apparatus comprising: at least one memory and at least one processor which function as: a communication unit configured to be capable of executing wireless communication in which the communication apparatus and an external apparatus communicate by wireless LAN without going through an external access point; a selection unit configured to select, from a plurality of methods, a method for the communication apparatus and the external apparatus to share a parameter used by the communication apparatus and the external apparatus to connect through the wireless communication, in accordance with a user operation; and a control unit configured to control processing for sharing the parameter between the communication apparatus and the external apparatus to be executed using the method selected by the selection unit, wherein the control unit is configured to control mutual authentication to be performed between the communication apparatus and the external apparatus after the processing for sharing the parameter using the method selected by the selection unit is performed.

According to the present disclosure, an appropriate parameter sharing method according to an environment of a communication apparatus can be selected.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating the configuration of a system.

FIGS. 2A and 2B are diagrams illustrating the configuration of an MFP.

FIGS. 3A to 3C are diagrams illustrating a console unit of the MFP.

FIGS. 4A and 4B are diagrams illustrating the configuration of a mobile terminal device.

FIG. 5 is a diagram illustrating the configuration of an access point.

FIG. 6 is a sequence chart illustrating connection processing in the WFD standard.

FIG. 7 is a sequence chart illustrating connection processing in the WFD standard.

FIGS. 8A to 8H are diagrams illustrating user interface screens.

FIGS. 9A to 9F are diagrams illustrating user interface screens.

FIGS. 10A and 10B are flowcharts illustrating processing for determining a parameter sharing method.

FIG. 11 is a flowchart illustrating processing for determining a parameter sharing method.

FIGS. 12A and 12B are flowcharts illustrating processing for determining a parameter sharing method.

FIG. 13 is a flowchart illustrating network setup mode processing.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

In a predetermined WFD standard, a plurality of parameter sharing methods necessary for making connections between devices may be present. On the other hand, there are various environments in which communication apparatuses are used, and it may be desirable to use a more secure parameter sharing method, or a more convenient parameter sharing method.

According to the present disclosure, an appropriate parameter sharing method according to an environment of a communication apparatus can be selected.

### System Configuration

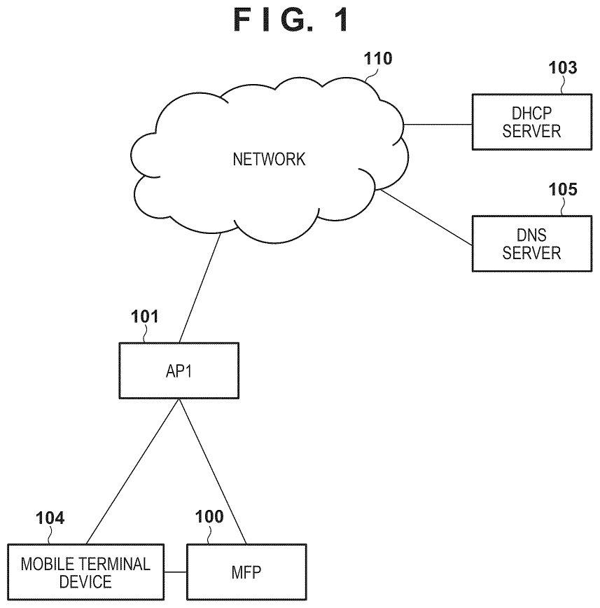

FIG. 1 illustrates an example of the configuration of a system according to the present embodiment. In one example, this system is a wireless communication system in which a plurality of communication apparatuses can communicate with each other wirelessly. In the example illustrated in FIG. 1, a mobile terminal device 104 and an MFP 100 serving as communication apparatuses, an AP 101 serving as an access point, a DHCP server 103, a DNS server 105, and a network 110 are provided. The mobile terminal device 104 is a device having a wireless communication function that uses wireless LAN or the like. “Wireless LAN” may be called “WLAN” hereinafter. The mobile terminal device 104 may be a personal information terminal such as a Personal Digital Assistant (PDA), a mobile phone (a smartphone), a digital camera, a personal computer, or the like.

The MFP 100 is a printing device having a printing function, and may further have a reading function (a scanner), a fax function, a telephone function, and the like. The MFP 100 according to the present embodiment also has a communication function that enables wireless communication with the mobile terminal device 104. Although the present embodiment describes a case where the MFP 100 is used as an example, the configuration is not limited thereto. For example, a scanner device, a projector, a mobile terminal, a smartphone, a laptop PC, a tablet terminal, a PDA, a digital camera, a music playback device, a television, a smart speaker, or the like, which has a communication function, may be used instead of the MFP 100. Note that “MFP” is an acronym for “Multi Function Peripheral”.

The AP 101 is provided separate from (outside) the mobile terminal device 104 and the MFP 100, and functions as a WLAN base station device. A communication apparatus having a WLAN communication function can communicate in WLAN infrastructure mode via the AP 101. Note that access points may be called “APs” hereinafter. Infrastructure mode may also be called “wireless infrastructure mode”. The AP 101 communicates wirelessly with a communication apparatus that has permitted (authenticated) a connection to itself, and relays wireless communication between that communication apparatus and other communication apparatuses. The AP 101 can, for example, be connected to a wired communication network, and can relay communication between a communication apparatus connected to that wired communication network and another communication apparatus wirelessly connected to the AP 101.

The DHCP server 103 connects to the MFP 100 via the AP 101 and the network 110, and provides services to the MFP 100 by responding to requests from the MFP 100. Although FIG. 1 illustrates a configuration in which the DHCP server 103 is connected as a device separate from the AP 101, the configuration may be such that the AP 101 has DHCP server functionality. The DNS server 105 is connected to the MFP 100, the mobile terminal device 104, and the like via the AP 101 and the network 110, and provides services for name resolution by responding to requests from the MFP 100, the mobile terminal device 104, and the like. Here, the network 110 may be the Internet, or may be a private network in a business, a mobile phone network, or the like.

### External Configuration of MFP

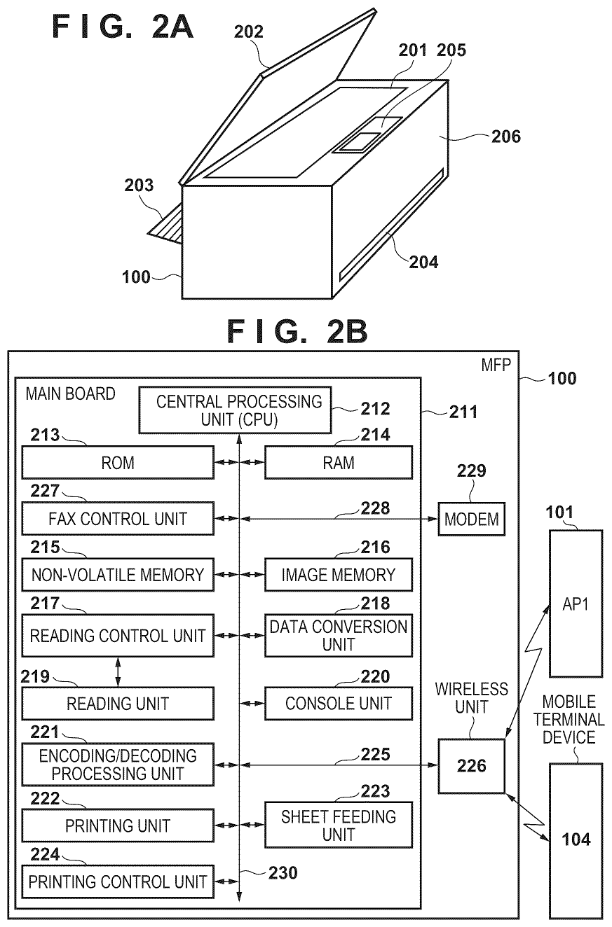

FIG. 2A illustrates an example of the external configuration of the MFP 100. The MFP 100 includes a document platform 201, a document cover 202, a printing paper insertion port 203, a printing paper discharge port 204, and a console unit 205, for example. The document platform 201 is a platform for placing a document to be read. The document cover 202 is a cover for securing a document placed on the document platform 201, and for ensuring that light from a light source that illuminates the document does not escape to the exterior when the document is being read. The printing paper insertion port 203 is an insertion port in which various sizes of sheets can be set. The printing paper discharge port 204 is a discharge port for discharging a sheet which has been printed onto. Paper set in the printing paper insertion port 203 is conveyed one sheet at a time to a printing unit, where the paper is printed onto and then discharged from the printing paper discharge port 204. The console unit 205 is configured including keys such as text input keys, a cursor key, an OK key, a cancel key, and the like, as well as LEDs, an LCD, and the like, and is configured such that a user can launch the various functions of the MFP, manipulate various settings, and the like. The console unit 205 may also be configured including a touch panel display. The MFP 100 has a WLAN wireless communication function and therefore is configured also including a wireless communication antenna 206 for that wireless communication, although the antenna 206 is not necessarily visible from the exterior. Like the mobile terminal device 104, the MFP 100 can communicate wirelessly over the WLAN in frequency bands such as the 2.4 GHz band, the 5 GHz band, the 6 GHz band, or the like.

### MFP Configuration

FIG. 2B illustrates an example of the configuration of the MFP 100. The MFP 100 is configured including a main board 211 that performs main control of the device itself, and a wireless unit 226, which is a single communication module that performs WLAN communication using at least one common antenna. The MFP 100 is also configured including a modem 229 for wired communication, for example. The main board 211 is configured including, for example, a CPU 212 (a central processing unit), a ROM 213, a RAM 214, a non-volatile memory 215, an image memory 216, a reading control unit 217, a data conversion unit 218, a reading unit 219, and an encoding/decoding processing unit 221. The main board 211 also includes, for example, a printing unit 222, a sheet feeding unit 223, a printing control unit 224, and a console unit 220. The function units in the main board 211 are connected to each other by a system bus 230 managed by the CPU 212. Additionally, the main board 211 and the wireless unit 226 are connected, for example, by a dedicated bus 225, and the main board 211 and the modem 229 are connected, for example, by a bus 228.

The CPU 212 is a system control unit including at least one processor, and controls the MFP 100 as a whole. The processing by the MFP 100 described below is implemented by the CPU 212 executing programs stored in the ROM 213, for example. Note that dedicated hardware for each process may be provided. The ROM 213 stores control programs executed by the CPU 212, embedded OS programs, and the like. In the present embodiment, the CPU 212 performs software control such as scheduling, task switching, and the like by executing each control program stored in the ROM 213 under the management of an embedded OS, which is also stored in the ROM 213.

The RAM 214 is constituted by an SRAM or the like. The RAM 214 stores data such as program control variables, data such as setting values registered by the user and management data of the MFP 100, and the like. In addition, the RAM 214 can be used as various types of working buffers. The non-volatile memory 215 is constituted by a memory such as a flash memory, for example, and continues to store data even when the MFP 100 is turned off. The image memory 216 is constituted by a memory such as a DRAM. The image memory 216 stores image data received through the wireless unit 226, image data processed by the encoding/decoding processing unit 221, and the like. Note that the memory configuration of the MFP 100 is not limited to the configuration described above. The data conversion unit 218 analyzes data in various formats, converts image data into print data, and the like.

The reading control unit 217 controls the reading unit 219 (e.g., a contact-type image sensor (CIS)) to optically read a document placed on the document platform 201. The reading control unit 217 converts an image obtained by optically reading the document into electrical image data (an image signal) and outputs the image data. At this time, the reading control unit 217 may perform various types of image processing, such as binarization, half-tone processing, and the like before outputting the image data.

The console unit 220 is the console unit 205 described with reference to FIG. 2A, and displays items on a display based on display control by the CPU 212, generates signals in response to accepting user operations, and the like.

The encoding/decoding processing unit 221 performs encoding processing, decoding processing, scaling processing, and the like on image data handled by the MFP 100 (JPEG, PNG, and the like).

The sheet feeding unit 223 holds sheets for printing. The sheet feeding unit 223 can supply sheets set therein under the control of the printing control unit 224. The sheet feeding unit 223 may include a plurality of sheet feeding units to hold a plurality of types of sheets in a single apparatus, and from which sheet feeding unit sheets are fed can be controlled under the control of the printing control unit 224.

The printing control unit 224 applies various types of image processing, such as smoothing processing, print darkness correction processing, color correction, and the like, to the image data to be printed, and outputs the processed image data to the printing unit 222. The printing unit 222 is configured to be capable of executing ink jet printing processing, for example, so that ink supplied from an ink tank is ejected from a print head and an image is printed on a printing medium such as paper. Note that the printing unit 222 may be configured to be capable of executing other types of printing processing, such as electrophotographic printing. The printing control unit 224 can also periodically read out information on the printing unit 222 and update status information and the like stored in the RAM 214, including the remaining amount of ink in the ink tank, the state of the print head, and the like.

The wireless unit 226 is a unit capable of providing a WLAN communication function, and is capable of providing functions equivalent to a combination with a WLAN unit 429 of the mobile terminal device 104, for example. In other words, according to the WLAN standard, the wireless unit 226 converts data into packets and sends the packets to other devices, and also restores packets from other external apparatuses into the original data thereof and outputs the data to the CPU 212. The wireless unit 226 is capable of communicating as a station compliant with the IEEE 802.11 standard series. The wireless unit 226 is particularly capable of communicating as a station compliant with IEEE 802.11a/b/g/n/ac/ax. “Stations” may be called “STA” hereinafter.

The wireless unit 226 supports IEEE 802.11ax, i.e., Wi-Fi 6 (registered trademark), and is capable of processing compliant with IEEE 802.11ax. In other words, the MFP 100 is capable of either or both of processing as a STA that supports (is compliant with) OFDMA, and operations (processing) as a STA that supports (is compliant with) TWT. “OFDMA” is an acronym for “Orthogonal Frequency-Division Multiple Access”. “TWT” is an acronym for “Target Wake Time”. Supporting TWT means that the timing of data communication from a parent device to the STA is adjusted.

The wireless unit 226 (the MFP 100) serving as the STA shifts the communication function to a sleep state when there is no need to stand by for signal reception. This makes it possible to suppress power consumption. The wireless unit 226 also supports Wi-Fi 6E (registered trademark). In other words, the wireless unit 226 is also capable of communicating in the 6 GHz band (5.925 GHz to 7.125 GHz). Unlike the 5 GHz band, the 6 GHz band does not have a band in which Dynamic Frequency Selection (DFS) is performed. As such, in communication in the 6 GHz band, communication will not be cut off due to DFS standby time, which can be expected to improve the communication. Although processing compliant with IEEE 802.11ax is assumed to be performed here, the mobile terminal device 104 and the MFP 100 may operate in compliance with other standards in the IEEE 802.11 series. For example, the operations may be compliant with IEEE 802.11be or a later standard.

Note that the mobile terminal device 104 and the MFP 100 are capable of P2P (WLAN) communication based on WFD, and the wireless unit 226 has a software access point (software AP) function or a group owner function. In other words, the wireless unit 226 is capable of constructing P2P communication networks, setting channels to use in P2P communication, and the like. WFD is assumed here to be based on a standard formulated by the Wi-Fi Alliance. The wireless unit 226 can also operate as a WFD client.

### MFP Console Unit

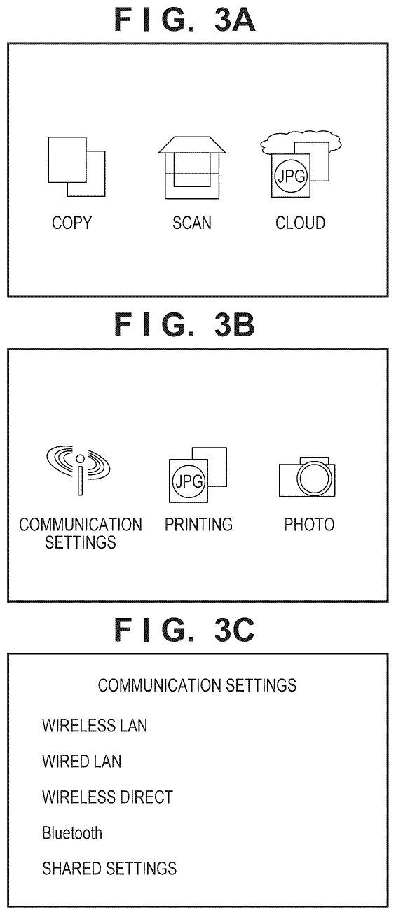

FIGS. 3A to 3C schematically illustrate examples of screens displayed in a display (a touchscreen) included in the console unit 220 of the MFP 100. FIG. 3A illustrates an example of a home screen displayed when the MFP 100 is turned on and operations such as printing, scanning, or the like are not underway (an “idle state” or a “standby state”). In FIG. 3A, display items indicating “Copy”, “Scan”, and “Cloud” (menu items) are displayed. “Cloud” is a menu item related to a cloud function that uses Internet communication. Settings in the MFP 100 can be made, the execution of functions can be started, and the like by operating keys, the touch panel, or the like to select one of the menu items. The MFP 100 can seamlessly display a screen different from that illustrated in FIG. 3A by accepting an operation of a key, the touch panel, or the like in the home screen illustrated in FIG. 3A.

FIG. 3B is an example of the display of another part of the home screen, and is a screen transitioned to in response to an operation for displaying another page of the home screen (an operation for sliding to the left or the right) being made in the state illustrated in FIG. 3A. In FIG. 3B, display items (menu items) indicating “Communication Settings”, “Print”, and “Photo” are displayed. When one of these menu items is selected, the function corresponding to the selected menu item, i.e., one of a printing function, a photo function, and communication settings, is executed.

FIG. 3C is an example of the display of a menu screen for the communication settings, displayed when “Communication Settings” has been selected in the screen illustrated in FIG. 3B. The communication settings menu screen is a network settings screen in which “Wireless LAN”, “Wired LAN”, “Wireless Direct”, “Bluetooth”, and “Common Settings” are displayed as menu items (options) in the communication settings menu screen. “Wireless LAN”, “Wired LAN”, and “Wireless Direct” are menu items for LAN settings, and settings such as wired connection settings, settings for enabling and disabling a wireless infrastructure mode, settings for enabling and disabling a P2P mode such as WFD and software AP mode, and the like can be set using these items. When the “Wireless LAN” item is selected and the wireless LAN is enabled by a user operation, wireless infrastructure mode is enabled. When the “Wireless Direct” item is selected and Wireless Direct is enabled by a user operation, the P2P (WLAN) mode is enabled. A common settings menu for each connection format is also displayed in this screen. Furthermore, the user can set the frequency band, frequency channel, and the like of the wireless LAN from this screen.

### External Configuration of Mobile Terminal Device

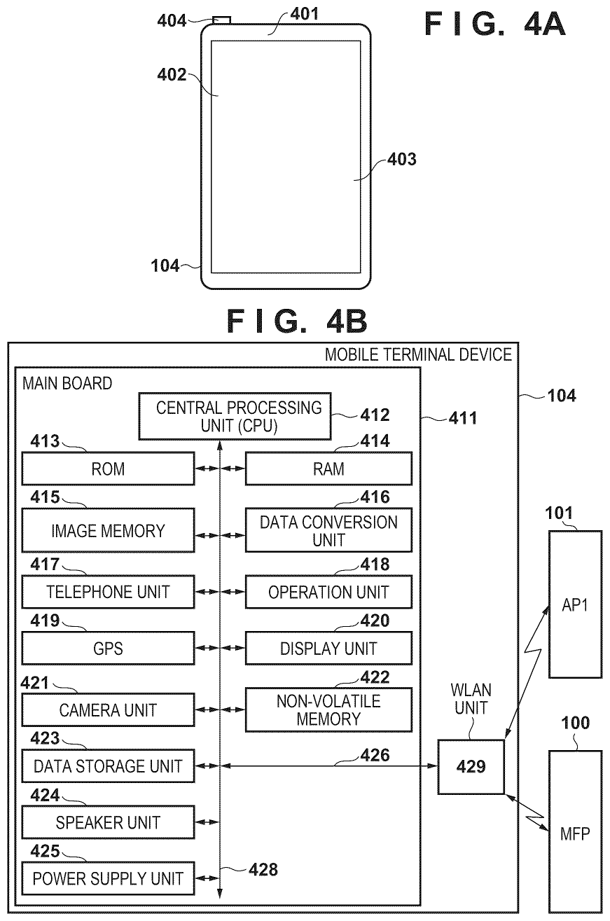

FIG. 4A is a diagram illustrating an example of the external configuration of the mobile terminal device 104. The present embodiment will describe a case where the mobile terminal device 104 is a typical smartphone, for example. Note that the mobile terminal device 104 is configured including a display unit 402, an operation unit 403, and a power key 404, for example. The display unit 402 is a display having a Liquid Crystal Display (LCD)-based display mechanism, for example. Note that the display unit 402 may display information using a Light Emitting Diode (LED) or the like, for example. The mobile terminal device 104 may also have a function for outputting information by audio in addition to or instead of the display unit 402. The operation unit 403 is configured including physical keys such as keys, buttons, and the like, a touch panel, and the like for detecting user operations. Note that in this example, the information display in the display unit 402 and the acceptance of user operations by the operation unit 403 are performed using a common touch panel display, and thus the display unit 402 and the operation unit 403 are implemented as a single device. In this case, for example, button icons or a software keyboard are displayed using a display function of the display unit 402, and the user touching those locations is detected using an operation reception function of the operation unit 403. Note that the display unit 402 and the operation unit 403 may be separate, and the hardware for display and the hardware for accepting operations may be provided individually. The power key 404 is a physical key for accepting user operations for turning the mobile terminal device 104 on or off.

The mobile terminal device 104 includes a WLAN unit 401, which provides WLAN communication functionality, but is not necessarily visible from the exterior. The WLAN unit 401 is configured to be capable of data (packet) communication in a WLAN system compliant with the IEEE 802.11 standard series (IEEE 802.11a/b/g/n/ac/ax and the like), for example. The WLAN unit 401 is also capable of communicating as an AP that supports Wi-Fi Agile Multiband (registered trademark). However, the configuration is not limited thereto, and the WLAN unit 401 may be capable of communication in a WLAN system compliant with another standard. This example assumes that the WLAN unit 401 is capable of communicating in the 2.4 GHz, 5 GHz, and 6 GHz frequency bands. The WLAN unit 401 is also assumed to be capable of communication based on WFD, communication using the software AP mode, communication using the wireless infrastructure mode, and the like. Operations performed in these modes will be described later.

### Configuration of Mobile Terminal Device

FIG. 4B illustrates an example of the configuration of the mobile terminal device 104. The mobile terminal device 104 includes a main board 411 that performs main control of the device itself, and the WLAN unit 429 that performs WLAN communication, for example. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym of “Central Processing Unit”, ROM is an acronym of “Read Only Memory”, RAM is an acronym of “Random Access Memory”, and GPS is an acronym of “Global Positioning System”. The mobile terminal device 104 also includes a display unit 420 and an operation unit 418. The function units in the main board 411 are connected to each other by a system bus 428 managed by the CPU 412. Additionally, the main board 411 and the WLAN unit 429 (the aforementioned WLAN unit 401) are connected, for example, by a dedicated bus 426.

The CPU 412 is a system control unit including at least one processor, and controls the mobile terminal device 104 as a whole. The processing by the mobile terminal device 104 described below is implemented by the CPU 412 executing programs stored in the ROM 413, for example. Note that dedicated hardware for each process may be provided. The ROM 413 stores control programs executed by the CPU 412, embedded operating system (OS) programs, and the like. In the present embodiment, the CPU 412 performs software control such as scheduling, task switching, and the like by executing each control program stored in the ROM 413 under the management of an embedded OS, which is also stored in the ROM 413.

The RAM 414 is constituted by a Static RAM (SRAM) or the like. The RAM 414 stores data such as program control variables, data such as setting values registered by the user and management data of the mobile terminal device 104, and the like. In addition, the RAM 414 can be used as various types of working buffers. The image memory 415 is constituted by a memory such as a Dynamic RAM (DRAM) or the like. The image memory 415 temporarily stores image data received through the WLAN unit 429, image data read out from the data storage unit 423, and the like for processing by the CPU 412. The non-volatile memory 422 is constituted by a memory such as a flash memory, for example, and continues to store data even when the mobile terminal device 104 is turned off. Note that the memory configuration of the mobile terminal device 104 is not limited to the configuration described above. For example, the image memory 415 and the RAM 414 may be implemented by the same memory, data may be backed up using the data storage unit 423, or the like. Additionally, although the present embodiment describes a DRAM as an example of the image memory 415, another storage medium such as a hard disk, a non-volatile memory, or the like may be used instead.

The data conversion unit 416 analyzes data in various formats, performs data conversion such as color conversion and image conversion, and the like. The telephone unit 417 controls a telephone line, and implements telephone communication by processing audio data input and output through the speaker unit 424. The GPS 419 receives radio waves transmitted from a satellite and obtains location information such as the current latitude, longitude, and the like of the mobile terminal device 104.

The camera unit 421 has a function for electronically recording and encoding an image input through a lens. The image data captured by the camera unit 421 is stored in the data storage unit 423. The speaker unit 424 performs control for implementing a function for inputting or outputting audio for the telephone function, other functions such as alarm notifications, and the like. The power supply unit 425 is a portable battery, for example, and controls the supply of power to the interior of the device. Power states include, for example, a “battery depleted state” in which there is no power remaining in the battery, a “power off state” in which the power key 404 has not been pressed, an “operating state” in which the battery is running normally, and a “power-saving state” in which the battery is operating but is in a power saving state.

The display unit 420 is the display unit 402 described with reference to FIG. 4A, and displays various types of input operations, the operating state and status of the MFP 100, and the like under the control of the CPU 412. The operation unit 418 is the operation unit 403 described with reference to FIG. 4A, and when a user operation is accepted, performs control such as generating an electrical signal corresponding to the operation, outputting the electrical signal to the CPU 412, and the like.

The mobile terminal device 104 performs wireless communication using the WLAN unit 429, and performs data communication with other devices such as the MFP 100. The WLAN unit 429 converts data into packets and sends the packets to other devices. The WLAN unit 429 also restores packets from other external devices into the original data and outputs the data to the CPU 412. The WLAN unit 429 is a unit for implementing communication compliant with each WLAN standard. The WLAN unit 429 can operate in at least two communication modes simultaneously, including wireless infrastructure mode and P2P (WLAN) mode. Note that the frequency bands used in these communication modes can be limited by the functions and performance of the hardware.

### Configuration of Access Point

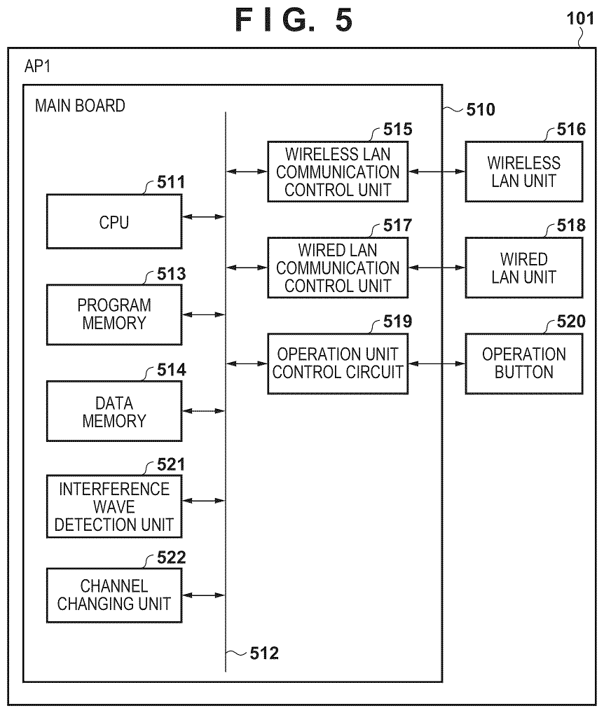

FIG. 5 is a block diagram illustrating the configuration of the AP 101 having a wireless LAN access point function. A main board 510, which controls the AP 101, is configured including a wireless LAN unit 516, a wired LAN unit 518, and an operation button 520.

A microprocessor-type CPU 511 disposed on the main board 510 operates in accordance with a control program stored in a ROM-type program memory 513 and data in a RAM-type data memory 514, which are connected to the CPU 511 by an internal bus 512. The CPU 511 communicates with other communication terminal devices over a wireless LAN by controlling the wireless LAN unit 516 through a wireless LAN communication control unit 515. The CPU 511 also communicates with other communication terminal devices over a wired LAN by controlling the wired LAN unit 518 through a wired LAN communication control unit 517. The CPU 511 is capable of accepting operations made by a user manipulating the operation button 520, by controlling an operation unit control circuit 519. The CPU 511 includes at least one processor.

The AP 101 also includes an interference wave detection unit 521 and a channel changing unit 522. The interference wave detection unit 521 performs interference wave detection processing when communicating wirelessly in a band in which Dynamic Frequency Selection (DFS) is implemented. When communicating wirelessly in a band in which DFS is implemented, the channel changing unit 522 performs processing for changing the channel used when interference waves are detected, when it is necessary to immediately change to a free channel, and the like.

### P2P Communication Method

An overview of a P2P (WLAN) communication method for devices to wirelessly communicate directly with each other without traversing an external access point in WLAN communication will be given next. P2P (WLAN) communication can be implemented through a plurality of methods, e.g., the communication apparatus can support a plurality of modes for P2P (WLAN) communication and selectively execute P2P communication (WLAN) using one of the plurality of modes.

The following two modes are assumed as P2P modes.
Software AP Mode
Wi-Fi Direct (WFD) Mode

A communication apparatus capable of P2P communication can be configured to support at least one of these modes. However, even a communication apparatus capable of P2P communication does not have to support all of these modes, and may be configured to support only some.

In a communication apparatus having a WFD communication function (e.g., the mobile terminal device 104), an application for implementing the communication function (in some cases, a dedicated application) is called in response to a user operation being accepted through the operation unit of the device. The communication apparatus can then display a screen of a user interface (UI) provided by the application to prompt the user to perform an operation, and then perform WFD communication on the basis of the user operation accepted in response thereto.

### Software AP Mode

Jn the software AP mode, the communication apparatus (e.g., the mobile terminal device 104) operates in the role of a client requesting various types of services. The other communication apparatus (e.g., the MFP 100) operates as a software AP capable of performing WLAN AP functions through software settings. Note that commands, parameters, and the like sent and received when establishing a wireless connection between the client and the software AP may be any specified by the Wi-Fi (registered trademark) standard, and will therefore not be described. The MFP 100 operating in software AP mode also determines a frequency band and a frequency channel as a parent station. Accordingly, the MFP 100 can select which frequency band to use from 2.4 GHz, 5 GHz, or 6 GHz, as well as which frequency channel to use in that frequency band. In the software AP mode, there is no negotiation for determining roles, and there is no need to comply with the WFD standard formulated by the Wi-Fi Alliance.

### WFD Mode

Jn the present embodiment, the mobile terminal device 104 and the MFP 100 support functions disclosed as Wi-Fi Direct. “Wi-Fi Direct” is a function through which a device supporting Wi-Fi Direct can establish its own Wi-Fi network without the need for an Internet connection. Specifically, devices supporting Wi-Fi Direct, such as the mobile terminal device 104 and the MFP 100, can connect directly to each other even in an environment without an AP 101 or the like. The MFP 100 may be started so as to be fixed as the parent station for WFD mode (Autonomous Group Owner). In this case, GO Negotiation processing for determining the role is unnecessary. Furthermore, in this case, the MFP 100 also determines the frequency band and the frequency channel to be used as the parent station. Accordingly, the MFP 100 can select which frequency band to use from 2.4 GHz, 5 GHz, or 6 GHz, as well as which frequency channel to use in that frequency band. Furthermore, in the WFD mode, the configuration may be such that GO Negotiation is performed to determine which device will operate as the group owner and which device will operate as the client.

### Wireless Infrastructure Mode

In wireless infrastructure mode, communication apparatuses that communicate with each other (e.g., the mobile terminal device 104 and the MFP 100) are connected to an external AP that manages the network (e.g., the AP 101), and the communication apparatuses communicate with each other through the AP. In other words, communication between the communication apparatuses is executed over a network constructed by an external AP. The mobile terminal device 104 and the MFP 100 both discover the AP 101, and by sending a connection request and connecting to the AP 101, those communication apparatuses can communicate in wireless infrastructure mode via the AP 101. Note that a plurality of communication apparatuses may be connected to individual separate APs. In this case, the communication apparatuses can communicate by data being transferred among the APs. The commands, parameters, and the like sent and received during communication between the communication apparatuses via the access points may be any specified by the Wi-Fi standard, and will therefore not be described. In this case, the AP 101 also determines the frequency band and the frequency channel. Accordingly, the AP 101 can select which frequency band to use from 2.4 GHz, 5 GHz, or 6 GHz, as well as which frequency channel to use in that frequency band.

The following will describe the WFD standard has having a method for a first standard, and a method for a second standard different from the method for the first standard. In other words, in the WFD standard, a plurality of methods with different standard versions are present. Here, the method for the first standard will be referred to as WFD R1 (Release 1), and the method for the second standard will be referred to as WFD R2 (Release 2). WFD R1 and WFD R2 use different methods for searching for devices and sharing parameters. Note that in the present embodiment, “sharing parameters” includes sending and receiving (exchanging) parameters through communication between devices without requiring user operations, and parameter information being recognized by devices through a user operation such as reading a QR code.

### First Connection Processing by Method Using First Standard

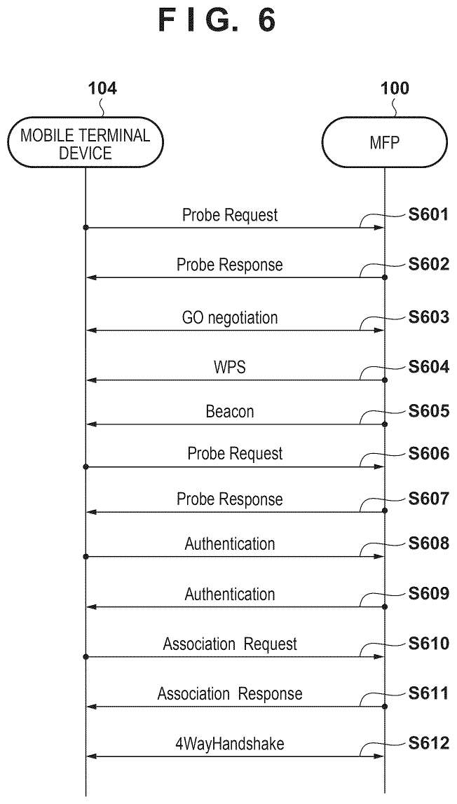

FIG. 6 is a sequence chart illustrating processing by which the mobile terminal device 104 and the MFP 100 connect in accordance with the WFD standard. A processing sequence for WFD R1 is illustrated here. Processing executed by each device in this sequence is implemented by the CPU of each device reading out various programs stored in a memory provided in that device, such as a ROM or the like, into a RAM and executing those programs.

For example, the processing of the sequence is started in the mobile terminal device 104 and the MFP 100 in response to receiving an instruction to start WFD from the user. Upon receiving the operation for starting WFD from the user, the mobile terminal device 104 and the MFP 100 search for a partner device by repeating a Listen state and a Search state. These states may be preceded by a period for scanning each channel. In the Listen state, for example, the device selects channel 1 in the 2.4 GHz band and stands by for a Probe Request frame from another communication apparatus. In the Search state, the device sends the Probe Request frame while switching the frequency channel (e.g., between channel 1, channel 6, and channel 11), and stands by for a Probe Response frame.

In step S601, the mobile terminal device 104 sends a Probe Request frame to search for a WFD communication apparatus. The partner device to be searched for is searched for by sending the Probe Request frame. It is assumed here that the communication apparatus performing the search is the mobile terminal device 104, and the partner device being searched for is the MFP 100. The Probe Request frame has a WFD attribute (P2P IE), which specifies that the target of the search is a WFD communication apparatus.

In step S602, upon receiving the Probe Request frame, the MFP 100 sends a Probe Response frame. The mobile terminal device 104 detects the MFP 100 that is the target of WFD communication by receiving the Probe Response frame sent by the MFP 100. Note that the Probe Request frame and the Probe Response frame include P2P IE, and may also include a Multi-Link element. The Multi-Link element may include communication parameters used for multi-link communication as specified in the IEEE 802.11be standard. Through this, a plurality of links can be set in a single connection procedure between the communication apparatuses. In this manner, in WFD R1, the presence of another communication apparatus can be detected using first search processing, which uses using the Probe Request/Probe Response frames. The first search processing described above is a WFD R1 search sequence.

In step S603, the mobile terminal device 104 and the MFP 100 perform GO Negotiation processing. The channel to be used for direct wireless communication may be determined in the GO Negotiation. In the GO Negotiation processing, the mobile terminal device 104 and the MFP 100 send and receive GO Negotiation Request/GO Negotiation Response frames, which include an intent value indicating the degree to which the device intends to be the GO. The GO Negotiation Request/GO Negotiation Response frames determine the roles of P2P group owner (GO) and P2P client. The MFP 100 may be started so as to be fixed as the parent station (GO) for WFD mode (Autonomous Group Owner). In this case, GO Negotiation processing for determining the role is unnecessary. The MFP 100 may ensure it itself always operates as the GO, despite the GO Negotiation processing being executed, by setting the intent value for itself to a maximum of 15. Furthermore, in this case, the MFP 100 also determines the frequency band and the frequency channel to be used in direct wireless communication as the parent station. Accordingly, the MFP 100 can select the frequency band to use, namely 2.4 GHz or 5 GHz, as well as which frequency channel to use in that frequency band.

In step S604, the mobile terminal device 104 and the MFP 100 share communication parameters through Wi-Fi Protected Setup (WPS) processing. The communication parameters may include parameters used for wireless communication, such as Service Set Identifier (SSID), an encryption method, a cryptographic key, an authentication method, an AKM, a BSSID, a MAC Address, and the like. “AKM” is an acronym for “Authentication and Key Management”. “AKM” indicates an authentication protocol, a key exchange algorithm, and the like used for wireless communication. For example, if the AKM is “SAE”, the communication parameters can include a password for connecting to an AP or a GO supporting Wi-Fi Protected Access (WPA) 3. If the AKM is “psk”, the communication parameters can include a Pre Shared Key (PSK)/passphrase for connecting to an AP or a GO supporting WPA 2. If the AKM is “1×”, an ID, a password, a public key, and the like for connecting to an AP supporting WPA-Enterprise can be included. Note that passwords, PSKs, and passphrases are cryptographic keys used when implementing authentication and key exchange based on WPA, IEEE 802.11, and the like. The WPS processing in step S604 is a WFD R1 communication parameter sharing sequence. Alternatively, a channel changed from the channel used in steps S601 to S603 may be used for communication in the processing from step S604 onward.

In step S605, when the MFP 100 itself is determined to operate as the GO, the MFP 100 starts sending a beacon frame. The beacon frame can include communication parameters for communicating with the MFP 100. The beacon frame can also include an information element (IE), Attributes, or the like defined in the WFD standard. Through this, communication apparatuses other than the mobile terminal device 104 can also detect the presence of the MFP 100 and make a wireless communication connection with the MFP 100 directly. For example, other communication apparatuses can detect the presence of the MFP 100 by receiving the Beacon frame including information defined in the WFD standard.

In step S606, the mobile terminal device 104 sends a Probe Request frame to execute a connection procedure with the MFP 100. In step S607, upon receiving the Probe Request frame, the MFP 100 sends a Probe Response frame.

In step S608, the mobile terminal device 104 sends an Authentication frame. In step S609, upon receiving the Authentication frame, the MFP 100 sends an Authentication frame.

In step S610, upon receiving the Authentication frame, the mobile terminal device 104 sends an Association Request frame. In step S611, upon receiving the Association Request frame, the MFP 100 sends an Association Response frame.

In step S612, the mobile terminal device 104 and the MFP 100 execute a 4-Way Handshake.

In the method for the first standard, the connection between the mobile terminal device 104 and the MFP 100 is established by executing a connection procedure such as that as described above. Although not indicated in the foregoing sequence, the mobile terminal device 104 and the MFP 100 may send or receive Provision Discovery Request/Provision Discovery Response frames. The processing performed by the mobile terminal device 104 and the MFP 100 illustrated above may also be configured to be performed in an inverse manner.

### Second Connection Processing by Method Using Second Standard

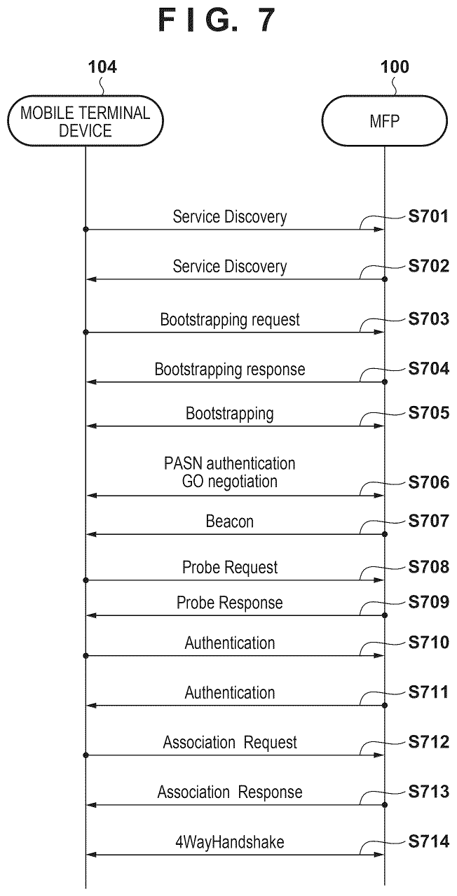

FIG. 7 is a sequence chart illustrating processing by which the mobile terminal device 104 and the MFP 100 connect in accordance with the WFD standard. A processing sequence for WFD R2 is illustrated here. Processing executed by each device in this sequence is implemented by the CPU of each device reading out various programs stored in a memory provided in that device, such as a ROM or the like, into a RAM and executing those programs.

For example, the processing of the sequence is started in the mobile terminal device 104 and the MFP 100 in response to receiving an instruction to start WFD from the user. In the WFD R2 search sequence, second search processing is performed. An example of a search procedure using the second search processing will be described. In this search procedure, the mobile terminal device 104 and the MFP 100 each executes processing based on whether the device itself is a communication apparatus providing a service or a communication apparatus requesting a service, and detect other communication apparatuses. The communication apparatus providing the service can be called a Publisher, a Listener, an Advertiser, or the like. The communication apparatus requesting the service can be called a Subscriber, a Searcher, a Seeker, or the like. For example, the communication apparatus requesting the service can send frames to detect other communication apparatuses. The communication apparatus providing the service can receive and respond to frames sent by other communication apparatuses. The role assigned to the communication apparatus can be determined by the upper layer (the service layer or the like).

FIG. 7 illustrates an example in which the mobile terminal device 104 operates as the communication apparatus requesting the service and the MFP 100 operates as the communication apparatus providing the service. For example, the mobile terminal device 104 performs detection operations intermittently and sends frames for detecting other communication apparatuses. The Wi-Fi Aware standard system formulated by the Wi-Fi Alliance, for example, may be used in the second search processing. In other words, frames specified in the Wi-Fi Aware standard may be used as the frames communicated in the second search processing. Additionally, the second search processing is not limited to the Wi-Fi Aware standard, and other service search protocols and methods may be used.

In step S701, the mobile terminal device 104 sends a Service Discovery frame to search for a WFD communication apparatus. It is assumed here that Service Discovery is sent on channel 6 in the 2.4 GHz band. The partner device to be searched for is searched for by sending the Service Discovery frame. It is assumed here that the communication apparatus performing the search is the mobile terminal device 104, and the partner device being searched for is the MFP 100. The Service Discovery frame has a WFD attribute, which specifies that the target of the search is a WFD communication apparatus.

In step S702, upon receiving the Service Discovery frame, the MFP 100 sends a Service Discovery frame. The Service Discovery frame sent here is called an “SDF Follow up”. The mobile terminal device 104 detects the MFP 100 that is the WFD communication partner by receiving the Service Discovery frame. The second search processing described above is a WFD R2 search sequence. Because the first search processing in WFD R1 and the second search processing in WFD R2 use different methods, the WFD R2 method cannot be used to search for a communication apparatus which only supports WFD R1. Likewise, the WFD R1 method cannot be used to search for a communication apparatus which only supports WFD R2.

In step S703, the mobile terminal device 104 sends a request using a Bootstrapping Request frame. Here, the request is a request for a sharing method for the purpose of sharing communication parameters. The mobile terminal device 104 can use this frame to notify the MFP 100 of a sharing method that the mobile terminal device 104 itself can execute from among communication parameter sharing methods which use a button (an approval operation-based method), a pin code, a passphrase, a QR code, a Near Field Communication (NFC) tag, or the like, for example. The present embodiment will describe a QR code as an example of a two-dimensional code image. For example, if the mobile terminal device 104 is capable of executing a sharing method that uses a QR code, the mobile terminal device 104 can indicate at least one of whether the mobile terminal device 104 itself is capable of displaying a QR code or capable of reading a QR code. If the mobile terminal device 104 is capable of executing a sharing method that uses a passphrase, the mobile terminal device 104 can also indicate whether a character string, a numerical value, or both can be used. If the mobile terminal device 104 is capable of executing a sharing method that uses a passphrase, the mobile terminal device 104 can indicate whether the passphrase can be displayed, entered, or both. The mobile terminal device 104 can also indicate whether a trigger for sharing communication parameters by pressing a button can be used. The information that can be communicated by the mobile terminal device 104 is not limited thereto.

In step S704, in response to the request using the Bootstrapping Request frame, the MFP 100 sends a response to the mobile terminal device 104 using a Bootstrapping Response frame. In one example, the MFP 100 can select a sharing method that can be executed by the MFP 100 itself from among the sharing methods included in the request from the mobile terminal device 104, and provide a response that includes information capable of identifying the sharing method. In addition, if there is no method that can be executed by the device itself from among the sharing methods included in the request, a response that includes information indicating this fact can be provided.

In step S705, Bootstrapping processing is performed using the sharing method for sharing the communication parameters determined between the communication apparatuses, and the communication parameters are shared. For example, the communication parameters are shared by the MFP 100 displaying a QR code and the mobile terminal device 104 reading the QR code. The Bootstrapping processing in step S705 is a WFD R2 communication parameter sharing sequence. The communication parameters shared here include at least one (one or more) parameters used for wireless communication, from among an encryption method, a cryptographic key, an authentication method, AKM, and a BSSID (MAC address). A passphrase is also included when the parameters are shared by QR code.

In step S706, mutual authentication can be executed through PASN authentication. “PASN” is an acronym for “Preassociation Security Negotiation”. The communication parameters for using PASN can include a public key or the like of each communication apparatus. The communication parameters for using PASN can be shared using a method not specified in the WFD standard, such as Bluetooth or Bluetooth Low Energy. Alternatively, as another sharing method, a temporary network including an AP may be configured and the communication parameters may be obtained by connecting the communication apparatus to that network. In PASN, the mobile terminal device 104 and the MFP 100 can perform GO Negotiation processing. The channel to be used for direct wireless communication may be determined in the GO Negotiation. The roles of the P2P group owner (GO) and the P2P client are determined in the GO Negotiation processing. The MFP 100 may be started so as to be fixed as the parent station for WFD mode (Autonomous Group Owner). In this case, GO Negotiation processing for determining the role is unnecessary. The MFP 100 may ensure it itself always operates as the MFP 100, despite the GO Negotiation processing being executed, by setting the intent value for itself to a maximum of 15. Furthermore, in this case, the MFP 100 also determines the frequency band and the frequency channel to be used in direct wireless communication as the parent station. Accordingly, the MFP 100 can select which frequency band to use from 2.4 GHz, 5 GHz, or 6 GHz, as well as which frequency channel to use in that frequency band.

In WFD R1, the frequency bands that can be used for direct wireless communication are 2.4 GHz and 5 GHz, but in WFD R2, the frequency bands that can be used for direct wireless communication are assumed to be 2.4 GHz, 5 GHz, and 6 GHz. Furthermore, unlike WFD R1, the roles are determined after sharing the communication parameters in WFD R2. A channel changed from the channel used in steps S701 to S706 may be used for communication in the processing from step S707 onward.

In step S707, when the MFP 100 itself is determined to operate as the GO, the MFP 100 starts sending a beacon frame. The beacon frame can include communication parameters for communicating with the MFP 100. The beacon frame can also include an information element (IE), Attributes, or the like defined in the WFD standard. Through this, communication apparatuses other than the mobile terminal device 104 can also detect the presence of the MFP 100 and connect to the MFP 100. For example, other communication apparatuses can detect the presence of the MFP 100 by receiving the Beacon frame including information defined in the WFD standard.

In step S708, the mobile terminal device 104 sends a Probe Request frame to execute a connection procedure with the MFP 100. In step S709, upon receiving the Probe Request frame, the MFP 100 sends a Probe Response frame.

In step S710, the mobile terminal device 104 sends an Authentication frame. In step S711, upon receiving the Authentication frame, the MFP 100 sends an Authentication frame.

In step S712, upon receiving the Authentication frame, the mobile terminal device 104 sends an Association Request frame. In step S713, upon receiving the Association Request frame, the MFP 100 sends an Association Response frame.

In step S714, the mobile terminal device 104 and the MFP 100 execute a 4-Way Handshake.

In the method for the second standard, the connection between the mobile terminal device 104 and the MFP 100 is established by executing a connection procedure such as that as described above. The processing performed by the mobile terminal device 104 and the MFP 100 illustrated above may be configured to be performed in an inverse manner. Whether WFD R1 or WFD R2 is supported can also be indicated by P2P IE.

As described above, in the method for the second standard, a plurality of parameter sharing methods necessary to establish a connection between devices are present. Here, if, for example, parameters are shared using the QR code-based method, the user who made the instruction to send the parameter sharing request must be the same as the user who reads the QR code displayed on the display unit of the communication apparatus. On the other hand, if parameters are shared using a button-based method, it is possible that the user who made the instruction to send the parameter sharing request is different from the user who presses the button displayed on the display unit of the communication apparatus. It is therefore desirable to use the QR code-based method, in which the users are highly likely to be the same user, as the parameter sharing method. However, when using the QR code-based method, if an error is occurring in the communication apparatus, the display of error information should take precedence over the display of the QR code, and it may therefore be inappropriate to use a QR code. In the present embodiment, when establishing a connection using the method for the second standard, an appropriate parameter sharing method can be determined in accordance with the operation state of the communication apparatus.

In the method for the second standard, a plurality of parameter sharing methods necessary to establish a connection between devices are present, but the desired sharing method may be different depending on the user. For example, if the user uses the communication apparatus alone at home, a nonsecure method may be used as the parameter sharing method, and a simpler parameter sharing method is therefore desirable. On the other hand, if the user uses the communication apparatus in a public place, any number of people may connect. In such a case, a secure parameter sharing method is desirable even if the procedure becomes somewhat complicated. However, if the communication apparatus specifies the parameter sharing method unilaterally, the usability drops. In the present embodiment, when establishing a connection using the method for the second standard, an appropriate parameter sharing method can be determined in accordance with the environment of the communication apparatus.

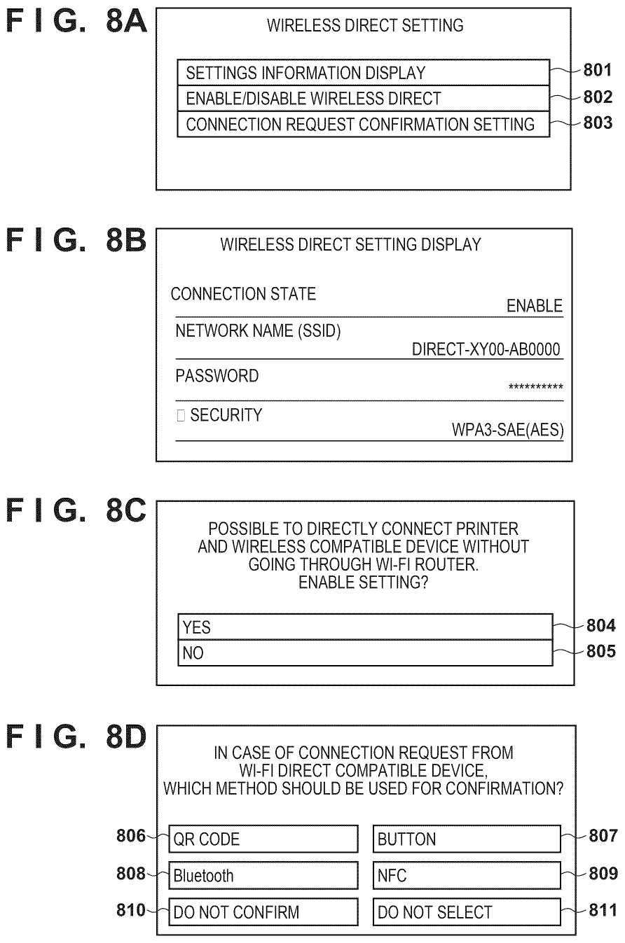

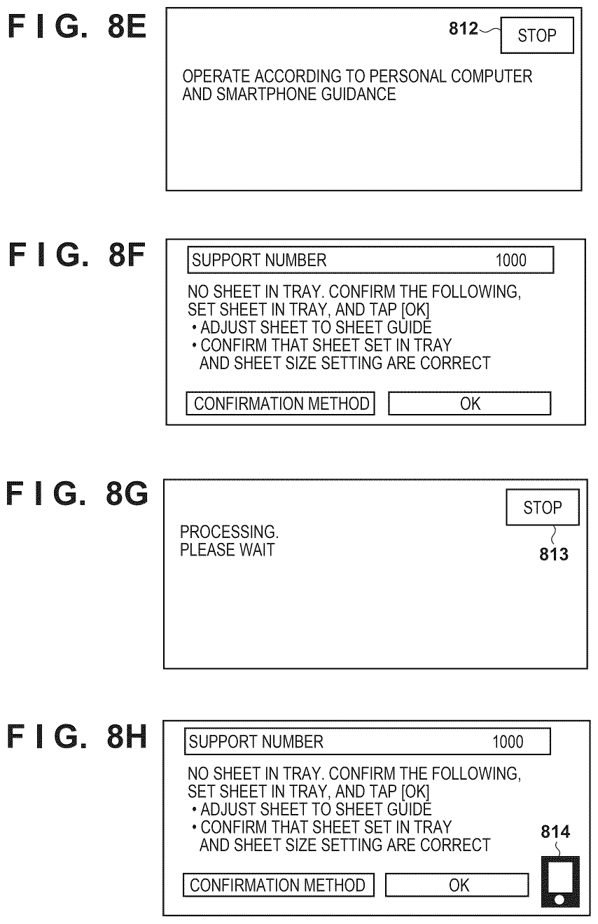

The present embodiment will be described next with reference to FIG. 8A and on. FIGS. 8A to 8H are diagrams illustrating examples of screens displayed in the console unit 220 of the MFP 100. The screens are not limited to those illustrated in FIGS. 8A to 8H, and other information may be included as well.

FIG. 8A is an example of the display of a menu screen for Wireless Direct, displayed when “Wireless Direct” has been selected in the screen illustrated in FIG. 3C. A “Settings Information Display” item 801, an “Enable/Disable Wireless Direct” item 802, and a “Connection Request Confirmation Settings” item 803 are displayed in the Wireless Direct menu screen.

FIG. 8B illustrates an example of the display of a settings display screen displayed when the “Settings Information Display” item 801 is selected in FIG. 8A. Items such as “Connection State”, “Network Name (SSID)”, “Password”, and “Wi-Fi Security”, as well as detailed information thereof, are displayed in the settings display screen.

FIG. 8C is an example of the display of a settings screen displayed when the “Enable/Disable Wireless Direct” item 802 is selected in FIG. 8A. A “Yes” button 804 and a “No” button 805 are displayed in the settings screen. If the “Yes” button 804 is selected, information indicating that the Wireless Direct setting is enabled for the MFP 100 is saved in the non-volatile memory 215. If the “No” button 805 is selected, information indicating that the Wireless Direct setting is disabled for the MFP 100 is saved in the non-volatile memory 215.

FIG. 8D is an example of the display of a settings screen displayed when the “Connection Request Confirmation Settings” item 803 is selected in FIG. 8A. A “QR Code” item 806, a “Button” item 807, a “Bluetooth” item 808, an “NFC” item 809, a “Do Not Confirm” item 810, and a “Do Not Select” item 811 are displayed in the settings screen. The “Do Not Confirm” item 810 being selected means that an instruction to execute a parameter sharing method that does not entail user operations is accepted. The “Do Not Select” item 811 being selected means that the parameter sharing method is not specified by the user, and in this case, an appropriate parameter sharing method is determined according to the operation state of the MFP 100. When one of these items is selected, the setting value for the parameter sharing method used for the connection in the WFD R2 in FIG. 7 is stored in the non-volatile memory 215. Note that the screen illustrated in FIG. 8D may be displayed when the “Yes” button 804 is selected in the screen illustrated in FIG. 8C.

FIG. 8E is an example of the display of a setup screen displayed when the MFP 100 starts processing for operating in a network setup mode in which a network setting request can be received from the outside (“network setup mode processing”, hereinafter).

In the present embodiment, the mobile terminal device 104 can execute processing for connecting the MFP 100 to a Local Area Network (LAN) that has already been constructed. Such processing is also referred to as “network setup”, and includes operations such as those described below.

A network setup instruction is sent from the mobile terminal device 104 to the MFP 100 in order to establish a wireless infrastructure connection between the mobile terminal device 104 and the MFP 100 and communicate over that connection. The wireless infrastructure connection is a connection made through an AP, e.g., when the mobile terminal device 104 and the MFP 100 connect to the same access point (AP) and communicate. The AP is included in a wireless LAN router, for example. In an MFP 100 that does not have a separate display device, it is not easy for the user to correctly enter identification information such as a Service Set Identifier (SSID), a password, and the like for the MFP 100 to connect to the AP. Accordingly, the mobile terminal device 104 temporarily makes a Wireless Direct connection to the MFP 100 that is in network setup mode, sends information such as the SSID, password, and the like for the AP to be connected to (called “AP setting information” hereinafter) as a network setting request to the MFP 100, and causes the MFP 100 to connect to the AP. For example, the mobile terminal device 104 obtains a list of APs to which the MFP 100 can connect from the MFP 100, and if an AP to which the mobile terminal device 104 was connected is included in the list, sends the AP setting information of the AP to which the mobile terminal device 104 was connected to the MFP 100. The MFP 100 then connects to the AP using the AP setting information received from the mobile terminal device 104. With such processing, the user does not need to operate the MFP 100 and the AP, which makes it easier for the user to perform the network setup for the MFP 100.

Text describing the operation to the user and a “Stop” button 812 are displayed in the setup screen. When the user selects the “Stop” button 812, the network setup mode processing for the MFP 100 is aborted.

FIG. 8F is an example of the display of an error screen displayed when the MFP 100 is in an error state, when an error has occurred. Note that the error state is a state in which the MFP 100 cannot print or scan, for example. The error screen displays a “Support Number” for determining the type of the error, text describing the error and a method for resolving the error, and the like.

FIG. 8G is an example of the display of a progress display screen for a job displayed when the MFP 100 is currently executing a job. Text describing the progress of the job and a “Stop” button 813 are displayed as the display content in the job progress display screen. When the user selects the “Stop” button 813, the job being executed by the MFP 100 is aborted.

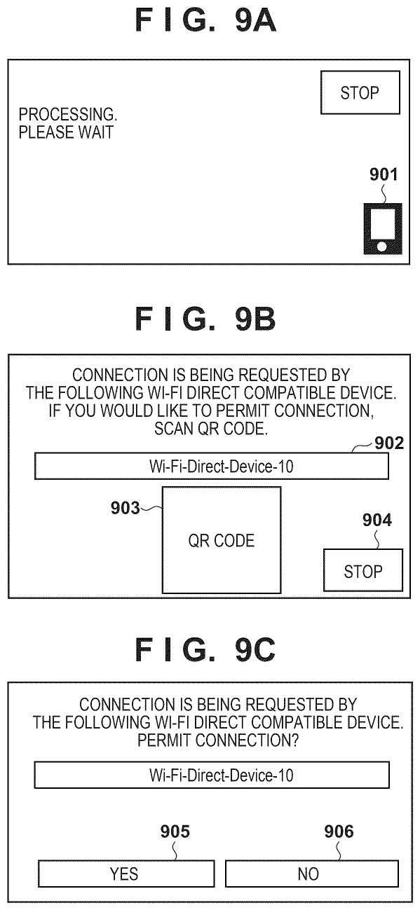

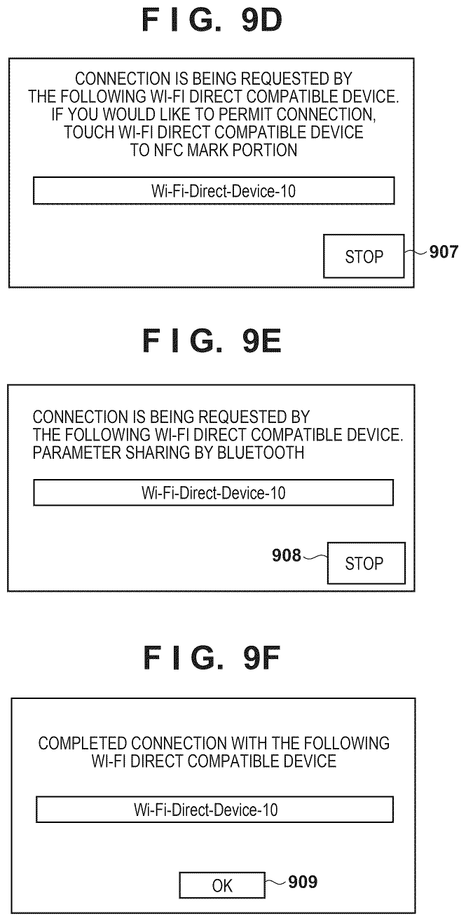

FIG. 8H is an example of the display of an error screen displayed when a parameter sharing request is received from the mobile terminal device 104 through the WFD R2 in FIG. 7 while an error is occurring in the MFP 100. The error screen illustrated in FIG. 8H is an error screen indicating an error state in which there are no sheets in the sheet feed tray for printing sheets. Printing cannot be performed if there are no sheets in the sheet feed tray. The “error” in the present embodiment is therefore assumed to be a state in which a process that can normally be executed by the MFP 100, such as printing, scanning, or the like, cannot be executed. An icon 814 is not displayed in the error screen before the parameter sharing request is received through the WFD R2 in FIG. 7, but the icon 814 is added to the error screen after the parameter sharing request is received. The icon 814 indicates that the parameter sharing request has been received, and is an operation item (display item) for displaying a confirmation screen for accepting approval to share the parameters (described later). In the present embodiment, when a parameter sharing request is received while the error screen is displayed, the method for sharing the parameters is a button-based method (an approval operation-based method). When the icon 814 is operated (pressed or touched), the screen transitions to a confirmation screen using the button-based method, illustrated in FIG. 9C. The confirmation screen is, in other words, a parameter sharing screen that enables the user to confirm whether to allow the parameters to be shared.

FIG. 9A is an example of the display of a progress display screen for a job displayed when a parameter sharing request is received from the mobile terminal device 104 through the WFD R2 in FIG. 7 while the MFP 100 is currently executing a job. The “job” in the present embodiment is, for example, a print job or a scan job. In other words, FIG. 9A is a screen displayed during printing or scanning. An icon 901 is not displayed in the progress display screen for the job before the parameter sharing request is received through the WFD R2 in FIG. 7, but the icon 901 is added to the progress display screen of the job when the parameter sharing request is received. The icon 901 indicates that the parameter sharing request has been received, and is an operation item (display item) for displaying a confirmation screen for obtaining approval to share the parameters. In the present embodiment, when a parameter sharing request is received while the job progress display screen is displayed, the method for sharing the parameters is a button-based method. When the icon 901 is operated (pressed or touched), the screen transitions to a confirmation screen using the button-based method, illustrated in FIG. 9C.

FIG. 9B is an example of the display of a parameter sharing screen displayed when sharing parameters using a QR code-based method in the connection process performed through the WFD R2 in FIG. 7 between the MFP 100 and the mobile terminal device 104. Text describing the operation to the user, a “Name of WFD-Compatible Device” item 902, a “QR code” item 903, and a “Stop” button 904 are displayed in the parameter sharing screen illustrated in FIG. 9B. The name of the mobile terminal device 104 executing the connection request through WFD is displayed in “Name of WFD-Compatible Device” item 902. A code image containing parameter information, such as a BSSID, a passphrase, or the like, for establishing a connection through the WFD R2 in FIG. 7, is displayed in the “QR code” item 903. When the user selects the “Stop” button 904, the WFD R2 connection process indicated in FIG. 7 is aborted. When sharing parameters by QR code, various parameters for making the connection are not sent over wireless communication radio waves. There is thus no risk of information being leaked due to wireless interception, and the parameters will not be leaked unless the QR code is read optically. However, it is necessary for the user to activate the camera of the mobile terminal device 104 to which the connection is to be made, and read the QR code.

FIG. 9C is an example of the display of a parameter sharing screen displayed when sharing parameters using a button-based method in the connection process performed through the WFD R2 in FIG. 7 between the MFP 100 and the mobile terminal device 104. Text describing the operation to the user is displayed in the parameter sharing screen illustrated in FIG. 9C. The text describing the operation a message indicating that a connection using the WFD R2 in FIG. 7 has been requested, and asking whether to approve the connection. In addition, identification information of the device that requested the parameters to be shared, a “Yes” button 905, and a “No” button 906 are displayed in the screen. The user selecting the “Yes” button 905 corresponds to an operation indicating that parameter sharing is allowed (approved) being performed, and the parameters necessary to establish the connection through the WFD R2 in FIG. 7 are shared between the MFP 100 and the mobile terminal device 104. On the other hand, if the user selects the “No” button 906, the WFD R2 connection processing between the MFP 100 and the mobile terminal device 104, indicated in FIG. 7, is aborted. In the button-based method, an operation for approving the parameter sharing is presented (displaying the “Yes” button 905, presenting a physical key to accept the approval operation, or the like) on the basis of the parameter sharing request (Bootstrapping Request) having been received. Then, when an approval operation is performed (a display button is operated, a physical key operation corresponding to the approval operation is performed, or the like), the parameters are sent by wireless communication to the device that made the parameter sharing request. In this manner, with the button-based method, the parameters can be shared through an easy user operation.

FIG. 9D is an example of the display of a parameter sharing screen displayed when sharing parameters using an NFC tag-based method in the connection process performed through the WFD R2 in FIG. 7 between the MFP 100 and the mobile terminal device 104. Text describing the operation to the user and a “Stop” button 907 are displayed in the parameter sharing screen illustrated in FIG. 9D. When the user brings the mobile terminal device 104 close to an NFC tag (not shown) provided in the MFP 100, the parameters necessary to establish a connection through the WFD R2 in FIG. 7 are shared between the MFP 100 and the mobile terminal device 104. On the other hand, when the user selects the “Stop” button 907, the connection processing through the WFD R2 in FIG. 7 between the MFP 100 and the mobile terminal device 104 is aborted.

FIG. 9E is an example of the display of a parameter sharing screen displayed when sharing parameters using a Bluetooth-based method in the connection process performed through the WFD R2 in FIG. 7 between the MFP 100 and the mobile terminal device 104. Text describing the operation to the user and a “Stop” button 908 are displayed in the parameter sharing screen illustrated in FIG. 9E. When a Bluetooth connection is established between the MFP 100 and the mobile terminal device 104, the parameters necessary to establish the WFD R2 connection, as described in FIG. 7, are shared. On the other hand, when the user selects the “Stop” button 908, the connection processing through the WFD R2 in FIG. 7 between the MFP 100 and the mobile terminal device 104 is aborted.

FIG. 9F is an example of the display of a connection completion screen displayed when a connection through the WFD R2 in FIG. 7 has been established between the MFP 100 and the mobile terminal device 104. Text describing the operation to the user and an “OK” button 909 are displayed in the connection completion screen. When the user selects the “OK” button 909, the screen transitions to the screen illustrated in FIG. 3A. The screen may transition to a different screen instead. Note that the screen illustrated in FIG. 9F may not be displayed when a connection through the WFD R2 in FIG. 7 has been established between the MFP 100 and the mobile terminal device 104.

### Processing for Determining WFD R2 Parameter Sharing Method

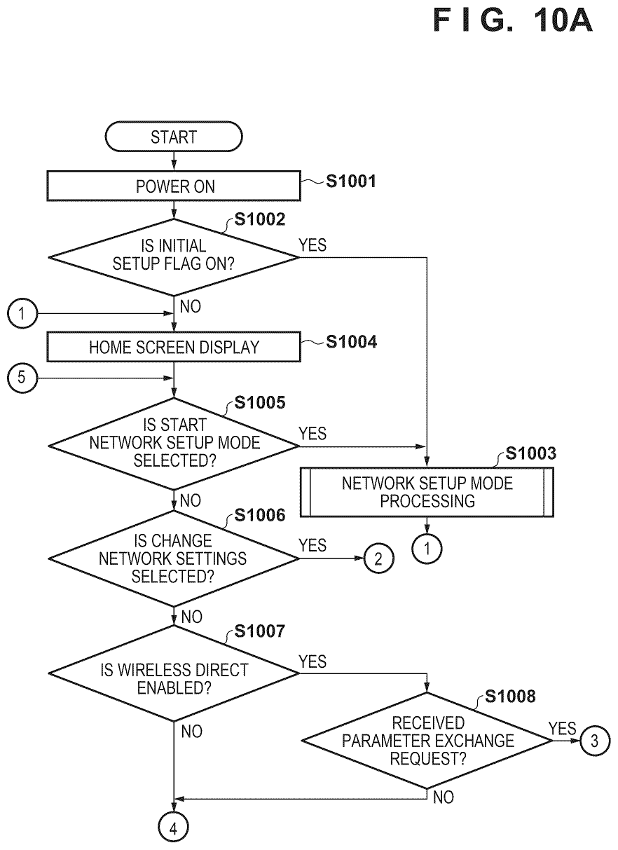

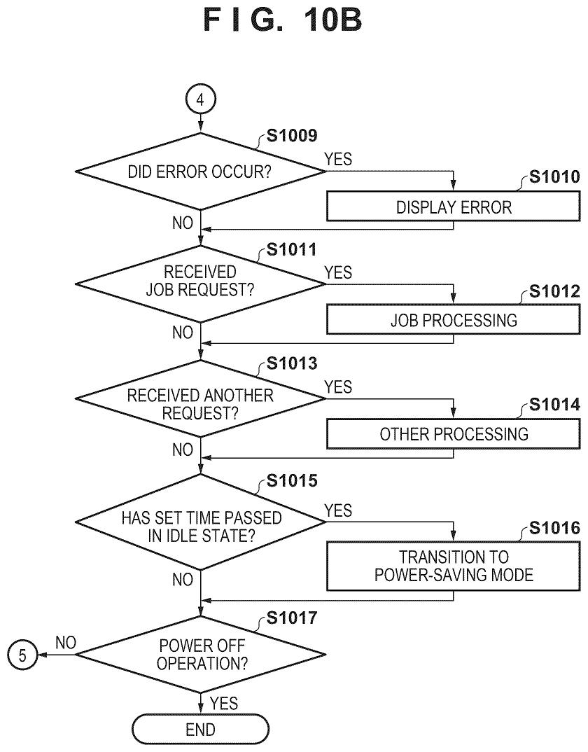

FIGS. 10A and 10B are flowcharts illustrating processing for determining a method for sharing parameters used to establish a connection through the WFD R2 in FIG. 7, executed by the MFP 100. In the present embodiment, the method for sharing the parameters used in the connection through the WFD R2 in FIG. 7 is determined on the basis of the operation state of the MFP 100, user settings, and the like. The processing illustrated in FIGS. 10A and 10B is implemented, for example, by the CPU 212 reading out various programs stored in a storage region such as the ROM 213 of the MFP 100 into the RAM 214 and executing those programs.

In step S1001, the CPU 212 turns the MFP 100 on. This processing for turning the power on may be executed by detecting an operation for turning the power on made by the user, or automatically, without requiring an operation by the user, by confirming that a specific condition, such as a timer being started up, has been met.

In step S1002, the CPU 212 determines whether an initial setup flag of the MFP 100 is on. If the initial setup flag is determined to be on, the sequence moves to step S1003. If the initial setup flag is determined not to be on, the sequence moves to step S1004. For example, the initial setup flag is on when initial setup has not yet been completed immediately after the user purchased the MFP 100. In other words, a case where the flag is determined to be on corresponds to a case where the MFP 100 is determined to have just arrived with the user. For example, when an ink tank is installed in the MFP 100 and the initial setup is completed to the point where the MFP 100 is capable of printing, the initial setup flag is turned off. In other words, a case where the flag is determined not to be on corresponds to a case where the MFP 100 is determined not to have just arrived with the user. The initial setup flag is stored in a storage region such as the RAM 214.

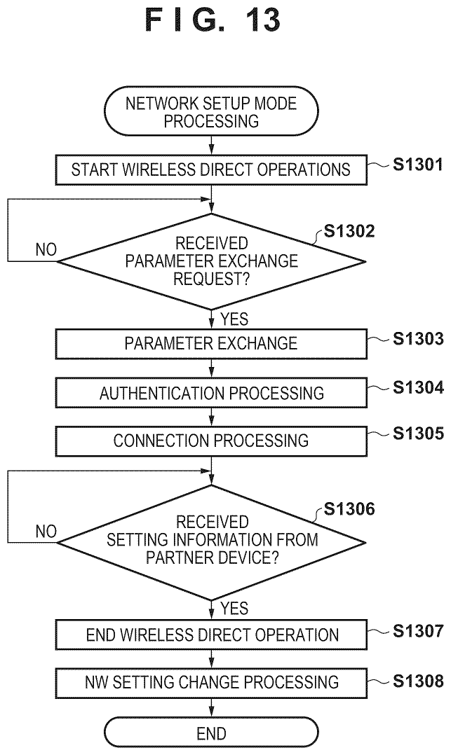

In step S1003, the CPU 212 executes the network setup mode processing to execute the network settings for the MFP 100. This network setup mode processing will be described with reference to FIG. 13.

In step S1004, the CPU 212 displays the home screen in the console unit 220. A screen such as that illustrated in FIG. 3A is displayed as the home screen, for example.

In step S1005, the CPU 212 determines whether the user has executed an operation for starting the network setup mode processing for the MFP 100. If the user is determined to have executed an operation for starting the network setup mode processing, the network setup mode processing is executed in step S1003. The operation for starting the network setup mode processing is, for example, pressing a predetermined software key on the screen displayed in the console unit 220, a physical key, or the like. On the other hand, the sequence moves to step S1006 if the user is determined not to have executed an operation for starting the network setup mode processing.

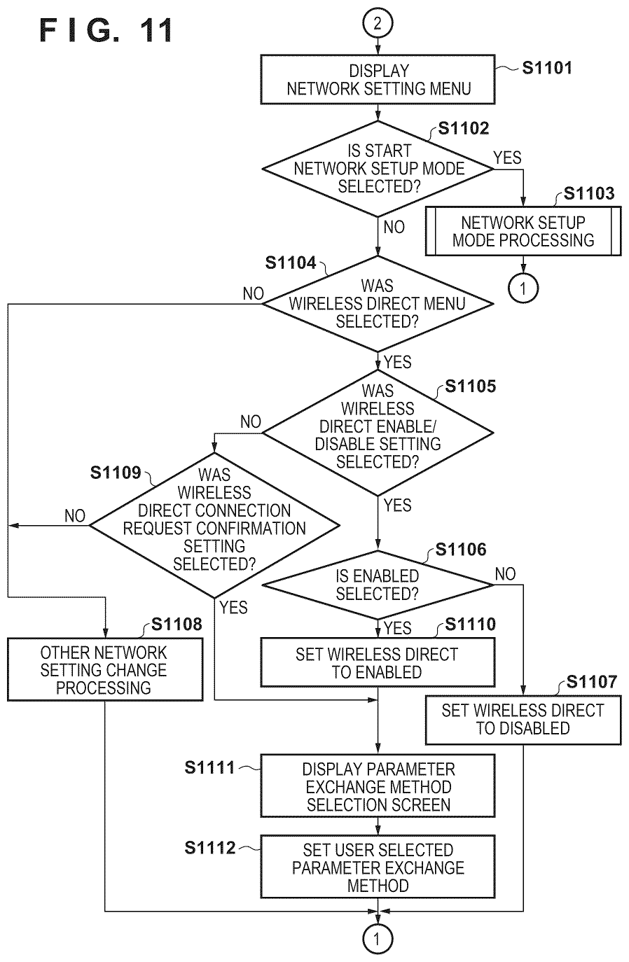

In step S1006, the CPU 212 determines whether the user has executed an operation for changing the network settings for the MFP 100. The operation for changing the network settings is an operation for displaying the screen illustrated in FIG. 3C, for example. The sequence moves to step S1101 of FIG. 11 if the user is determined to have executed an operation for changing the network settings. However, the sequence moves to step S1007 if the user is determined not to have executed an operation for changing the network settings.

In step S1101, the CPU 212 displays a network settings menu screen in the console unit 220. A screen such as that illustrated in FIG. 3C is displayed as the network settings menu screen, for example.

In step S1102, the CPU 212 determines whether the user has executed an operation for starting the network setup mode processing for the MFP 100. If the user is determined to have executed an operation for starting the network setup mode processing, the network setup mode processing is executed in step S1103. This network setup mode processing will be described with reference to FIG. 13. On the other hand, the sequence moves to step S1104 if the user is determined not to have executed an operation for starting the network setup mode processing.

In step S1104, the CPU 212 determines whether the “Wireless Direct” item has been selected from the network settings menu displayed in the console unit 220 of the MFP 100. If the “Wireless Direct” item is determined to have been selected, the sequence moves to step S1105. On the other hand, if the “Wireless Direct” item is determined not to have been, the sequence moves to step S1108.

In step S1108, the CPU 212 executes processing for changing settings other than “Wireless Direct”. The processing for changing settings other than “Wireless Direct” is, for example, processing for changing settings related to wireless infrastructure, processing for changing settings related to various protocols used in network communication, or the like.

In step S1105, the CPU 212 displays the wireless direct settings screen in the console unit 220, and determines whether the “Enable/Disable Wireless Direct” item for the MFP 100 has been selected. If the “Enable/Disable Wireless Direct” item is determined to have been selected, the sequence moves to step S1106. A screen such as that illustrated in FIG. 8A is displayed as the Wireless Direct settings screen, for example. On the other hand, if the “Enable/Disable Wireless Direct” item is determined not to have been selected, the sequence moves to step S1109.

In step S1106, the CPU 212 determines whether the setting to enable Wireless Direct for the MFP 100 has been selected. If the setting for enabling Wireless Direct is determined not to have been selected, the sequence moves to step S1107. On the other hand, if the setting for enabling Wireless Direct for the MFP 100 is determined to have been selected, the sequence moves to step S1110. For example, when item 802 illustrated in FIG. 8A is selected, the screen illustrated in FIG. 8C is displayed. Here, when the button 804 illustrated in FIG. 8C is selected, Wireless Direct is set to enabled, and when the button 805 illustrated in FIG. 8C is selected, Wireless Direct is set to disabled.

In step S1107, the CPU 212 stores information indicating that Wireless Direct is disabled for the MFP 100 in the non-volatile memory 215, and stops the Wireless Direct operation of the MFP 100.

In step S1110, the CPU 212 stores information indicating that Wireless Direct is enabled for the MFP 100 in the non-volatile memory 215, and starts the Wireless Direct operation of the MFP 100.

In step S1111, the CPU 212 displays, in the console unit 220, a screen for selecting the method to share the parameters for establishing a connection through the WFD R2 in FIG. 7 between the MFP 100 and the mobile terminal device 104. A screen such as that illustrated in FIG. 8D is displayed as the parameter sharing method selection screen, for example. Although the present embodiment describes displaying the parameter sharing method selection screen for all users, the parameter sharing method selection screen may be displayed only to users having administrator privileges if the MFP 100 is operating in a mode in which operation privileges differ depending on whether the user is an administrator or a general user. Here, in the parameter sharing method selection screen, the display may be controlled such that the user cannot select a method that is not provided in the MFP 100 or a method that is disabled by user settings. The display format for methods disabled in the user settings may also be controlled. Specifically, for example, methods disabled by user settings may be displayed in a different manner than methods not provided in the MFP 100 and methods enabled by user settings. Then, if the user selects a disabled method, the disabled method may be automatically changed to the enabled setting, and a confirmation screen may be displayed to confirm whether to change the disabled method to the enabled setting.

In step S1112, the CPU 212 stores information indicating the parameter sharing method selected by the user as a setting value in the non-volatile memory 215. Although only one parameter sharing method can be selected by the user in the present embodiment, it may be possible to select two or more parameter sharing methods. In this case, the appropriate parameter sharing method is determined according to the operation state of the MFP 100. Additionally, although the present embodiment describes the parameter sharing method stored in the non-volatile memory 215 as having only one setting value, if the configuration is such that the MFP 100 can store a setting value for each logged-in user, the setting value for the parameter sharing method may be stored in association with each logged-in user.

In step S1109, the CPU 212 determines whether the Wireless Direct connection request confirmation setting item of the MFP 100 has been selected. If the Wireless Direct connection request confirmation setting item is determined to have been selected, the sequence moves to step S1111, and the screen for selecting the method for sharing the parameters for establishing a connection through the WFD R2 in FIG. 7 is displayed in the console unit 220. On the other hand, if the Wireless Direct connection request confirmation setting item of the MFP 100 is determined not to have been selected, the sequence moves to step S1108.

As described above, network settings including settings for the parameter sharing method are made on the basis of the designation of items by the user in the network settings menu screen of the MFP 100.

In step S1007 of FIG. 10A, the CPU 212 determines whether Wireless Direct operation is enabled in the MFP 100 on the basis of the information stored in the non-volatile memory 215. Here, if the setting for Wireless Direct operation is determined not to be enabled, the sequence moves to step S1009. On the other hand, if the setting for the Wireless Direct operation is determined to be enabled, the sequence moves to step S1008.

In step S1009, the CPU 212 determines whether the MFP 100 is in a state in which an error has occurred, and if so, the sequence moves to step S1010. However, if the MFP 100 is determined not to be in a state in which an error has occurred, the sequence moves to step S1011.

In step S1010, the CPU 212 displays an error information screen in the console unit 220. A screen such as that illustrated in FIG. 8F is displayed as the error information screen, for example.

In step S1011, the CPU 212 determines whether the MFP 100 is receiving a job execution request, and if so, the sequence moves to step S1012. However, if the MFP 100 is determined not to have received a job execution request, the sequence moves to step S1013.

In step S1012, the CPU 212 displays a progress display screen for the job being executed in the console unit 220. A screen such as that illustrated in FIG. 8G is displayed as the job progress display screen, for example.

In step S1013, the CPU 212 determines whether the MFP 100 has received another request, and if so, the sequence moves to step S1014. However, if the MFP 100 is determined not to have received another request, the sequence moves to step S1015.

In step S1014, the CPU 212 executes processing in response to the other request. The other request includes, for example, a request to change the main unit settings of the MFP 100, a request to obtain information on the MFP 100 sent from the mobile terminal device 104, and the like. The request to change the main unit settings includes, for example, a request to change the device information, and specifically, the setting of the installation location of the MFP 100, for example. The setting for the installation location may be made configurable by accepting an input as a selection. For example, the selection items of whether security is required may be configured in parallel with the item for inputting the installation location.

In step S1015, the CPU 212 determines whether a set length of time has passed since the MFP 100 entered the idle state, and if so, the sequence moves to step S1016. However, if the set length of time is determined not to have passed since the MFP 100 entered the idle state, the sequence moves to step S1017. Note that the idle state is a state in which operations from the user are not being accepted.

In step S1016, the CPU 212 executes processing for transitioning the MFP 100 to a power-saving mode.

In step S1017, the CPU 212 determines whether an operation for turning the power off has been accepted from the user. If an operation for turning the power off is determined to have been accepted from the user, the CPU 212 executes processing for turning the power of the MFP 100 off. On the other hand, if an operation for turning the power off is determined not to have been accepted from the user, the sequence returns to step S1005.

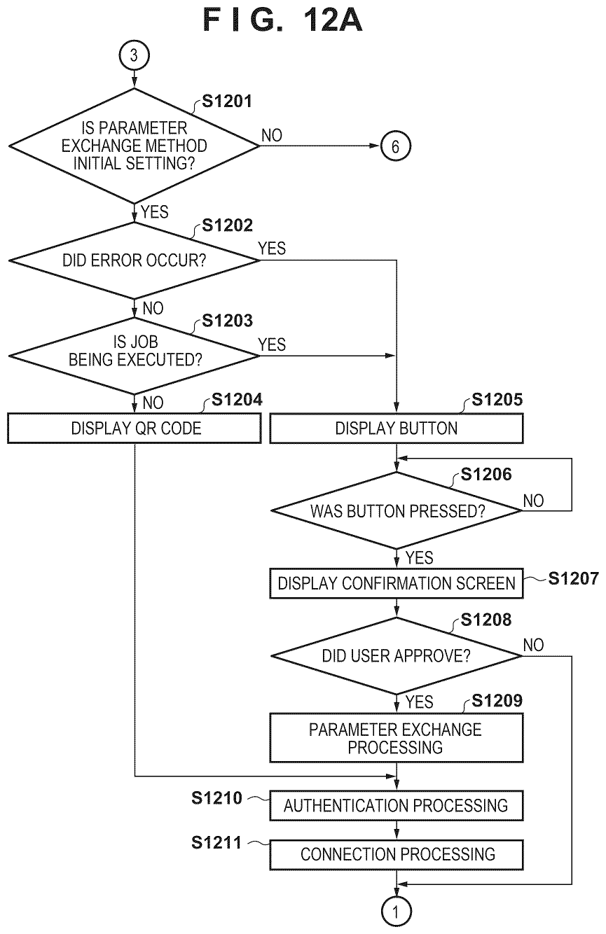

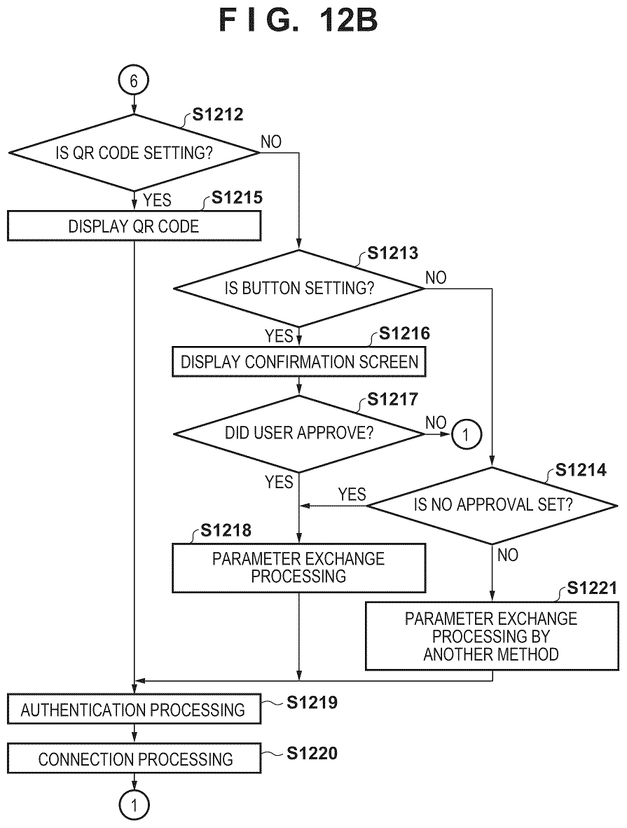

In step S1008, the CPU 212 determines whether a parameter sharing request (Bootstrapping Request) for establishing a connection between the MFP 100 and the mobile terminal device 104 through the WFD R2 in FIG. 7 has been received. The parameter sharing request sent from the mobile terminal device 104 to the MFP 100 corresponds to the processing of step S703 in FIG. 7, and the parameter sharing request includes information on the parameter sharing methods supported by the mobile terminal device 104. If the MFP 100 is determined to have received a parameter sharing request from the mobile terminal device 104, the sequence moves to step S1201 of FIG. 12A. On the other hand, if the parameter sharing request is determined not to have been received, the sequence moves to step S1009.

In step S1201, the CPU 212 determines the parameter sharing method for establishing a connection through the WFD R2 in FIG. 7 on the basis of the setting values stored in the non-volatile memory 215 of the MFP 100. Here, if the parameter sharing method is determined to be the initial setting, it is determined that the user has not designated the parameter sharing method, and the sequence moves to a flow for switching the parameter sharing method according to the operation state of the MFP 100, performed in steps S1202 to S1211. However, if the parameter sharing method is determined not to be the initial setting, the sequence moves to the flow for establishing a connection using the parameter sharing method specified by the user, performed in steps S1212 to S1221. Note that the parameter sharing method is the initial setting, for example, when the settings screen illustrated in FIG. 8D has not yet been displayed even once, and the default settings are still in place. Furthermore, the parameter sharing method is the initial setting when, for example, the button 811 is selected.

In step S1202, the CPU 212 determines whether the MFP 100 is in a state in which an error has occurred. If the MFP 100 is determined not to be in a state in which an error has occurred, the sequence moves to step S1203. However, if the MFP 100 is determined to be in a state in which an error has occurred, the sequence moves to step S1205.

In step S1203, the CPU 212 determines whether the MFP 100 is in a state in which a job is being executed. If the MFP 100 is determined not to be in a state in which a job is being executed, the sequence moves to step S1204. However, if the MFP 100 is determined to be in a state in which a job is being executed, the sequence moves to step S1205. A state in which a job is being executed is, for example, a state in which printing or scanning processing is being performed.

In step S1204, the CPU 212 sends a parameter sharing response (Bootstrapping Response) to the mobile terminal device 104. The parameter sharing response sent from the MFP 100 to the mobile terminal device 104 corresponds to the processing of step S704 in FIG. 7, and includes information on the parameter sharing method selected by the MFP 100. In the present embodiment, if the MFP 100 is not in a state in which an error has occurred and is not in a state in which a job is being executed, the parameter sharing method selected by the MFP 100 is the QR code-based method. The CPU 212 then displays a QR code screen (a code image) in the console unit 220. A screen such as that illustrated in FIG. 9B is displayed as the QR code screen, for example. The QR code displayed on the QR code screen includes parameters such as a BSSID and a passphrase for establishing a connection through the WFD R2 in FIG. 7. The mobile terminal device 104 then shares the parameters (Bootstrapping) by reading the QR code displayed in the console unit 220. This parameter sharing corresponds to the processing of step S705 in FIG. 7, and when the parameter sharing is complete, the sequence moves to step S1210.

In step S1210, the CPU 212 performs mutual authentication between the MFP 100 and the mobile terminal device 104 using PASN authentication. This mutual authentication corresponds to step S706 in FIG. 7, and when the mutual authentication is complete, the sequence moves to step S1211.

In step S1211, the CPU 212 executes connection processing between the MFP 100 and the mobile terminal device 104. This connection processing corresponds to steps S707 to S714 in FIG. 7. When the connection processing is complete, a wireless connection through the WFD R2 in FIG. 7 is established between the MFP 100 and the mobile terminal device 104. Note that when the wireless connection is established, the CPU 212 may display a connection completion screen in the console unit 220. A screen such as that illustrated in FIG. 9F is displayed as the connection completion screen, for example.

Note that if the MFP 100 is in a state in which an error has occurred, an error information screen is displayed in the console unit 220. A screen such as that illustrated in FIG. 8F is displayed as the error information screen, for example. Additionally, if the MFP 100 is in a state in which a job is being executed, a progress display screen for the job is displayed in the console unit 220. A screen such as that illustrated in FIG. 8G is displayed as the job progress display screen, for example.

In step S1205, the CPU 212 sends a parameter sharing response (Bootstrapping Response) to the mobile terminal device 104. The parameter sharing response sent from the MFP 100 to the mobile terminal device 104 corresponds to the processing of step S704 in FIG. 7, and the parameter sharing response includes information on the parameter sharing method selected by the MFP 100. In the present embodiment, if the MFP 100 is in a state in which an error has occurred or a state in which a job is being executed, a button-based method (approval operation-based method) is selected as the parameter sharing method. The CPU 212 then displays a button icon (a display item) in the screen displayed in the console unit 220 in order to guide the user to establish a Wireless Direct connection through the WFD R2 in FIG. 7. The button icon is, for example, the icon 814 in FIG. 8H or the icon 901 in FIG. 9A. In the present embodiment, the button icon is designed like a smartphone, for example, but the icon may have a different design.

In step S1206, the CPU 212 determines whether the button icon displayed in the console unit 220 has been selected by the user, and if so, the sequence moves to step S1207. Although the present embodiment describes the button icon as being displayed in the console unit 220 and determining whether the user has selected the button icon, whether the user has selected a predetermined physical key provided in the MFP 100 may be determined instead. The predetermined physical key is, for example, a physical key provided with an LED, where the LED is flashing.

In step S1207, the CPU 212 displays, in the console unit 220, a confirmation screen for confirming whether to allow the connection request through the WFD R2 in FIG. 7 from the mobile terminal device 104. A screen such as that illustrated in FIG. 9C is displayed as the confirmation screen, for example.

In step S1208, the CPU 212 determines whether the user has performed an approval operation (a permission operation) in the confirmation screen displayed in the console unit 220. If the user is determined to have performed the approval operation (e.g., has pressed the “Yes” button 905), the sequence moves to step S1209. However, if the user is determined not to have performed the approval operation, the CPU 212 aborts the connection processing through the WFD R2 in FIG. 7 between the MFP 100 and the mobile terminal device 104.

In step S1209, the CPU 212 performs parameter sharing (bootstrapping) between the MFP 100 and the mobile terminal device 104 through the WFD R2 in FIG. 7. This parameter sharing corresponds to the processing of step S705 in FIG. 7. Step S1209 includes processing for sending the parameters through wireless communication to the source of the parameter sharing request.

As described above, if the parameter sharing method is not specified by the user, an appropriate parameter sharing method is determined and executed in accordance with the operation state of the MFP 100 when the parameter sharing request is received.

In step S1212, the CPU 212 determines, on the basis of the setting values stored in the non-volatile memory 215 of the MFP 100, whether the setting for the parameter sharing method for establishing the connection through the WFD R2 in FIG. 7 is the QR code-based method, and if so, the sequence moves to step S1215. However, if the setting is determined not to be the QR code-based method, the sequence moves to step S1213. The processing of steps S1215, S1219, and S1220 are the same as the processing of steps S1204, S1210, and S1211, and will therefore not be described here.

In step S1213, the CPU 212 determines, on the basis of the setting values stored in the non-volatile memory 215 of the MFP 100, whether the parameter sharing method for establishing the connection through the WFD R2 in FIG. 7 is the button-based method, and if so, the sequence moves to step S1216. However, if the setting is determined not to be the button-based method, the sequence moves to step S1214. The processing of steps S1216, S1217, and S1218 are the same as the processing of steps S1207, S1208, and S1209, and will therefore not be described here.

In step S1214, the CPU 212 determines, on the basis of the setting values stored in the non-volatile memory 215 of the MFP 100, whether “Do Not Confirm” is selected for the parameter sharing method for establishing a connection through the WFD R2 in FIG. 7, and if so, the sequence moves to step S1218. However, if “Do Not Confirm” is determined not to have been selected, the sequence moves to step S1221.

In step S1221, the CPU 212 shares parameters for establishing a connection through the WFD R2 in FIG. 7 between the MFP 100 and the mobile terminal device 104 through another method. The other method includes, for example, a method using an NFC tag, Bluetooth, or the like. If “NFC Tag” has been selected as the parameter sharing method, the CPU 212 displays the screen illustrated in FIG. 9D, for example, in the console unit 220. If “Bluetooth” has been selected as the parameter sharing method, the CPU 212 displays the screen illustrated in FIG. 9E, for example, in the console unit 220.

Although the present embodiment describes only one parameter sharing method as being selectable by the user in steps S1212 to S1221, two or more methods may be selectable instead. In this case, for example, a priority level associated with the operation state of the MFP 100 may be set for each of the parameter sharing methods. For example, when the MFP 100 is in the idle state, the priority level of the QR code-based method is set to be higher than that of the other parameter sharing methods. Through this, even if, for example, the QR code-based method and the button-based method have been selected by the user, the appropriate parameter sharing method is thus determined according to the operation state of the MFP 100 when the parameter sharing request is received. Control using such a priority level may be performed using a table (described later).

### Network Setup Mode Processing

FIG. 13 is a flowchart illustrating processing performed when the MFP 100 executes network setup mode processing according to the present embodiment. The processing illustrated in FIG. 13 is implemented, for example, by the CPU 212 reading out various programs stored in a storage region such as the ROM 213 of the MFP 100 into the RAM 214 and executing those programs.

In step S1301, the CPU 212 starts Wireless Direct operations in the MFP 100. Although Wireless Direct starts operating in WFD mode in the present embodiment, Wireless Direct may instead start operating in both WFD mode and software AP mode.

In step S1302, the CPU 212 determines whether a parameter sharing request (Bootstrapping Request) for establishing a connection between the MFP 100 and the mobile terminal device 104 through the WFD R2 in FIG. 7 has been received. If the parameter sharing request is determined to have been received, the CPU 212 sends a parameter sharing response (Bootstrapping Response) to the mobile terminal device 104. The parameter sharing request, parameter sharing response, and the like correspond to the processing of steps S703 to S704 in FIG. 7.

In step S1303, the CPU 212 shares parameters (bootstrapping) for establishing a connection between the MFP 100 and the mobile terminal device 104 through the WFD R2 indicated in FIG. 7. In the present embodiment, if the MFP 100 is operating in network setup mode, the parameters are shared even without an approval operation from the user. In other words, the parameters are shared using a different method (sharing method) than both the QR code-based method and the button-based method. This parameter sharing corresponds to step S705 in FIG. 7.

In steps S1304 and S1305, a connection between the MFP 100 and the mobile terminal device 104 is established. This processing is the same as the processing of, for example, steps S1210 and S1211 in FIG. 9, and will therefore not be described here.

In step S1306, the CPU 212 determines whether a network setting request for the MFP 100 has been received from the mobile terminal device 104. If the network setting request is determined to have been received, the sequence moves to step S1307. The network setting request is a request to connect the MFP 100 to an external access point, and includes information on the external access point to which the MFP 100 is to connect, such as an SSID and the like.

In step S1307, the CPU 212 ends Wireless Direct operations in the MFP 100. In step S1308, the CPU 212 changes the network settings of the MFP 100 on the basis of the setting information included in the network setting request for the MFP 100, received from the mobile terminal device 104. In other words, the MFP 100 makes a wireless infrastructure connection to the AP on the basis of the received AP setting information.

FIGS. 12A and 12B illustrate a sequence where, if the parameter sharing method is determined to be the initial setting in step S1201, it is determined that the user has not designated the parameter sharing method, and the sequence moves to a flow for switching the parameter sharing method according to the operation state of the MFP 100, performed in steps S1202 to S1211. Additionally, the flow in steps S1202 to S1211 is described as displaying the QR code in S1204 when the state of the MFP 100 is a state in which an error has not occurred and a job is not being executed. However, the processing for determining the operation state of the MFP 100 in which the QR code is to be displayed is not limited thereto. For example, if the state of the MFP 100 is determined to be one of the idle state, the power-saving state, or an automatic power on standby state, the QR code may be displayed in step S1204, and the processing of steps S1210 and S1211 may then be executed. Note that “automatic power on” is a function that automatically turns on the MFP 100 when data is sent from the outside, and the automatic power on standby state is a state in which data is being received from the outside. Here, receiving data from the outside corresponds to a parameter sharing request, for example. According to the foregoing configuration, a user who has made a parameter sharing request through the mobile terminal device 104 can be made aware that the parameter sharing request has been received by the MFP 100 by displaying the QR code. Alternatively, when the state of the MFP 100 is determined to be the power-saving state or the automatic power on standby, and a predetermined physical key having an LED is provided in the console unit 220 of the MFP 100, a notification that the parameter sharing request has been received may be made using the LED. Specifically, for example, the predetermined physical key may be a button for making a Wireless Direct connection between the MFP 100 and the mobile terminal device 104, and the LED may be caused to flash when the parameter sharing request is received. The processing of steps S1209, S1210, and S1211 may then be executed when the physical key is pressed by the user.

Additionally, in the flow of steps S1202 to S1209, a button icon (a display item) is described as being displayed in the screen displayed in the console unit 220 in step S1205 when the state of the MFP 100 is determined to be a state in which an error has occurred or a state in which a job is being executed. However, the processing performed in such a case is not limited thereto. For example, a QR code may be displayed instead of or in addition to the button icon. Alternatively, when the state of the MFP 100 is determined to be a state in which an error has occurred or a state in which a job is being executed, and a predetermined physical key having an LED is provided in the console unit 220 of the MFP 100, a notification that the parameter sharing request has been received may be made using the LED. Specifically, for example, the predetermined physical key may be a button for making a Wireless Direct connection between the MFP 100 and the mobile terminal device 104, and the LED may be caused to flash when the parameter sharing request is received. The processing of steps S1209, S1210, and S1211 may then be executed when the physical key is pressed by the user.

Furthermore, FIGS. 10 and 11 illustrate the processing of FIG. 13 as being executed when the user is determined to have executed an operation for starting the network setup mode processing in steps S1005 and S1102. In other words, if the user is determined to have executed the processing for starting the network setup mode processing, the parameters are shared in step S1303 without a user operation being made, on the basis of the parameter sharing request being determined to have been received in step S1302. However, the processing is not limited thereto, and may be performed in response to a user operation. For example, if the parameter sharing request is determined to have been received in step S1302, a QR code may be displayed in the same manner as in step S1204. In this case, the same processing as in steps S1210 and S1211 is executed thereafter. Additionally, a notification that the parameter sharing request has been received may be made using a predetermined physical key having an LED, instead of or in addition to displaying the QR code. Specifically, for example, the predetermined physical key may be a button for making a Wireless Direct connection between the MFP 100 and the mobile terminal device 104, and the LED may be caused to flash when the parameter sharing request is received. The same processing as that of steps S1209, S1210, and S1211 may then be executed when the physical key is pressed by the user. Performing processing in response to a user operation in this manner makes it possible to cause the user to confirm that the parameters are to be shared.

Furthermore, FIGS. 10 and 11 illustrate the processing of FIG. 13 as being executed when the user is determined to have executed an operation for starting the network setup mode processing in steps S1005 and S1102. However, the processing illustrated in FIG. 13 may be executed on the basis of a predetermined event occurring, such as the MFP 100 being powered on. Then, in this case, if the parameter sharing request is determined to have been received in step S1302, a QR code may be displayed in the same manner as in step S1204. In this case, the same processing as in steps S1210 and S1211 is executed thereafter. Additionally, a notification that the parameter sharing request has been received may be made using a predetermined physical key having an LED, instead of or in addition to displaying the QR code. Specifically, for example, the predetermined physical key may be a button for making a Wireless Direct connection between the MFP 100 and the mobile terminal device 104, and the LED may be caused to flash when the parameter sharing request is received. The same processing as that of steps S1209, S1210, and S1211 may then be executed when the physical key is pressed by the user. Performing processing in response to a user operation in this manner makes it possible to cause the user to confirm that the parameters are to be shared.

The present embodiment assumes that the console unit 220 of the MFP 100 includes a panel. However, a configuration in which the console unit 220 does not include a panel, and only physical keys are provided, is also conceivable. In this case, when the state of the MFP 100 is the idle state, the power-saving state, the automatic power on standby state, a state in which an error has occurred, or a state in which is job is being executed, and the parameter sharing request is determined to have been received, the CPU 212 may make a notification that the parameter sharing request has been received by using a predetermined physical key having an LED. Specifically, for example, the predetermined physical key may be a button for making a Wireless Direct connection between the MFP 100 and the mobile terminal device 104, and the LED may be caused to flash when the parameter sharing request is received. The same processing as that of steps S1209, S1210, and S1211 may then be executed when the physical key is pressed by the user. Performing processing in response to a user operation in this manner makes it possible to cause the user to confirm that the parameters are to be shared.

Switching the parameter sharing method according to the operation state of the MFP 100 has been described with reference to FIGS. 12A and 12B. In the present embodiment, the parameter sharing method may be associated with the configuration of the MFP 100 and the operation state of the MFP 100 in advance. Here, the “configuration of the MFP 100” refers to whether the MFP 100 has/does not have a panel, has/does not have a predetermined physical key (i.e., uses a software key), and the like as described above. The association mentioned above may be stored in the non-volatile memory 215 as a table, for example. The CPU 212 may then refer to that table and execute control processing for switching the parameter sharing method. An example of such a table is shown below. Such a table may be used to implement the priority level for the parameter sharing methods described above. For example, even if the QR code-based method and the button-based method have been selected by the user, if, according to the following table, the operation state of the MFP 100 is the idle state when the parameter sharing request is received, the QR code-based method is preferentially determined as the parameter sharing method. The following table may also include other items. For example, the parameter sharing method may be switched in consideration of device information of the MFP 100. For example, if settings requiring security are set for the installation location of the MFP 100, the QR code-based method may be preferentially determined as the parameter sharing method.

TABLE 1

| MFP configuration | MFP state | Bootstrapping method |
|---|---|---|
| No panel | Idle | Button |
| | Error | Button |
| | Job running | Button |
| | Network setup mode | Button or automatic |
| | (manual) | |
| | Network setup mode | Button or automatic |
| | (automatic) | |
| | Power-saving | Button |
| | Automatic power on | Button |
| | standby | |
| With panel + | Idle | QR code |
| with | Error | Button |
| predetermined | Job running | Button |
| physical key | Network setup mode | QR code or automatic |
| | (manual) | |
| | Network setup mode | Button or automatic |
| | (automatic) | |
| | Power-saving | QR code |
| | Automatic power on | QR code or button |
| | standby | |
| With panel + | Idle | QR code |
| without | Error | Button |
| predetermined | Job running | Button |
| physical key | Network setup mode | QR code or automatic |
| (implemented by | (manual) | |
| software key) | Network setup mode | Button or automatic |
| | (automatic) | |
| | Power-saving | QR code |
| | Automatic power on | QR code |
| | standby | |

As described above, according to the present embodiment, the parameter sharing method can be switched in accordance with the configuration of the MFP 100, the state of the MFP 100, and the setting information. For example, switching the parameter sharing method on the basis of the setting information makes it possible to share the parameters through a method desired by the user. Additionally, when the parameter sharing method is switched on the basis of the state of the MFP 100, a screen such as that shown in FIGS. 8H and 9A is displayed, for example, if the state of the MFP 100 is a state in which an error has occurred and a state in which a job is being executed. According to such a configuration, the instruction to share the parameters can be received while prioritizing the notification of the state of the MFP 100. The appropriate parameter sharing method can also be executed in accordance with the configuration of the MFP 100.

With respect to the descriptions of the processing performed during the reception of print data in the present embodiment, the same processing can be applied during the reception of other data different from print data, or during the transmission of other data. For example, the same processing can be applied when scanning a document using the reading unit 219 and sending the scanned image (image data) to the mobile terminal device 104 via an external access point.

The above-described various types of control performed by the CPU 212 may be performed by a single piece of hardware, or the control of the apparatus as a whole may be performed by dividing the processing up among multiple pieces of hardware (e.g., multiple processors or circuits).

Although the foregoing embodiment describes a case where an MFP is applied as an example, the present embodiment is not limited to this example, and can be applied in any wireless device capable of P2P (WLAN) communication based on a WFD. In other words, the embodiment can be applied in personal computers, PDAs, tablet terminals, mobile telephone terminals such as smartphones, music players, game consoles, e-book readers, smart watches, various measurement devices (sensor devices) such as thermometers and hygrometers, and the like. The embodiment can also be applied in digital cameras (including still cameras, video cameras, network cameras, and security cameras), printers, scanners, and drones. The embodiment can also be applied in video output devices, audio output devices (e.g., smart speakers), streaming media players, wireless LAN client devices (adapters) to which USB terminals, LAN cable terminals, or the like can be connected, and the like. Video output devices include, for example, a device such as a set-top box, which obtains (downloads) a moving image or still image on the Internet, specified by a URL provided by a communication apparatus, and outputs the moving image or still image to a display device connected through a video output terminal such as an HDMI (registered trademark) terminal. Through this, streaming playback, a mirrored display (a display in which content displayed in a communication apparatus is also displayed on a display device), or the like is implemented in a display device. The video output device also includes a media player such as a television, a hard disk recorder, a Blu-ray recorder, a DVD recorder, or the like, as well as a head-mounted display, a projector, a television, a display device (monitor), a signage device, or the like. The embodiment can also be applied in a device capable of connecting through Wi-Fi, or what is known as a “smart home appliance”, such as an air conditioner, a refrigerator, a washing machine, a vacuum cleaner, an oven, a microwave oven, a lighting fixture, a heating appliance, a cooling appliance, or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-147847, filed Aug. 29, 2024 which is hereby incorporated by reference herein in its entirety.

What is claimed is:

1. A communication apparatus comprising:
at least one memory and at least one processor which function as:
a communication unit configured to be capable of executing wireless communication in which the communication apparatus and an external apparatus communicate by wireless LAN without going through an external access point;
a selection unit configured to select, from a plurality of methods, a method for the communication apparatus and the external apparatus to share a parameter used by the communication apparatus and the external apparatus to connect through the wireless communication, in accordance with a user operation; and
a control unit configured to control processing for sharing the parameter between the communication apparatus and the external apparatus to be executed using the method selected by the selection unit,
wherein the control unit is configured to control mutual authentication to be performed between the communication apparatus and the external apparatus after the processing for sharing the parameter using the method selected by the selection unit is performed.

2. The communication apparatus according to claim 1,
wherein the mutual authentication is performed using Preassociation Security Negotiation Authentication (PASN).

3. The communication apparatus according to claim 1,
wherein the plurality of methods include at least one of a first method, a second method, a third method, a fourth method, and a fifth method,
the first method is a method in which the parameter is shared between the communication apparatus and the external apparatus by the communication apparatus displaying a code image including information on the parameter and the external apparatus reading the code image,
the second method is a method in which the parameter is shared through the wireless communication between the communication apparatus and the external apparatus, based on a predetermined operation being performed in the communication apparatus,
the third method is a method in which the parameter is shared between the communication apparatus and the external apparatus after a request to share the parameter is received, without a user operation being performed in the communication apparatus and the external apparatus,
the fourth method is a method in which the parameter is shared between the communication apparatus and the external apparatus using a Near Field Communication (NFC) tag, and
the fifth method is a method in which the parameter is shared between the communication apparatus and the external apparatus using Bluetooth or Bluetooth Low Energy.

4. The communication apparatus according to claim 1,
wherein selection options corresponding to respective ones of the plurality of methods include a specific selection option,
the control unit is configured to control processing for sharing the parameter between the communication apparatus and the external apparatus to be executed using a method that varies according to an operation state of the communication apparatus, in a case where the specific selection option is selected in response to a user operation, and
the control unit is configured to:
control processing for sharing the parameter between the communication apparatus and the external apparatus to be executed using a first method in a case where the communication apparatus is in a first operation state; and
control processing for sharing the parameter between the communication apparatus and the external apparatus to be executed using a second method different from the first method, in a case where the communication apparatus is in a second operation state different from the first operation state.

5. The communication apparatus according to claim 1,
wherein the control unit is configured to control processing for sharing the parameter between the communication apparatus and the external apparatus to be executed using a method that varies according to an operation state of the communication apparatus, in a case where a request for sharing the parameter is received from the external apparatus in a state where the method is not selected in response to a user operation, and
the control unit is configured to:
control processing for sharing the parameter between the communication apparatus and the external apparatus to be executed using the first method in a case where the communication apparatus is in a first operation state; and
control processing for sharing the parameter between the communication apparatus and the external apparatus to be executed using a second method different from the first method, in a case where the communication apparatus is in a second operation state different from the first operation state.

6. The communication apparatus according to claim 1,
wherein the parameter shared between the communication apparatus and the external apparatus includes at least one of an encryption method, a cryptographic key, an authentication method, Authentication and Key Management (AKM), a BSSID, a MAC address, and a passphrase.

7. The communication apparatus according to claim 1,
wherein a selection screen for selecting the method is displayed on a display unit of the communication apparatus in a case where a wireless direct setting of the communication apparatus is enabled.

8. The communication apparatus according to claim 1,
wherein a selection screen for selecting the method is displayed in a case where an item pertaining to the method for sharing the parameter is selected in a screen displayed on a display unit of the communication apparatus.

9. The communication apparatus according to claim 1,
wherein in a case where administrator privileges are set in the communication apparatus, the method is selected in accordance with the user operation of only a user having the administrator privileges.

10. The communication apparatus according to claim 1,
wherein in a case where each of users are required to log in to the communication apparatus, information about the method selected by the selection unit is stored for each user that has logged in.

11. The communication apparatus according to claim 1,
wherein the selection unit is capable of selecting a plurality of methods, each being the method, in response to the user operation.

12. The communication apparatus according to claim 11,
wherein in a case where a request for sharing the parameter is received from the external apparatus in a state in which a plurality of the methods are selected by the selection unit in response to a user operation, the method according to an operation state of the communication apparatus is determined from the plurality of the methods selected, and
the control unit is configured to control processing for sharing the parameter between the communication apparatus and the external apparatus to be executed using the method determined.

13. The communication apparatus according to claim 1,
wherein in a selection screen for selecting the method, a method not provided in the communication apparatus or a method that is disabled in the communication apparatus is not selectable.

14. The communication apparatus according to claim 1,
wherein in a case where a method that is disabled in the communication apparatus is selected in a selection screen for selecting the method, the method selected is enabled without involving a user operation.

15. The communication apparatus according to claim 14,
wherein in a case where a method that is disabled in the communication apparatus is selected in the selection screen, a confirmation screen is displayed for causing a user to confirm whether to enable the method selected.

16. The communication apparatus according to claim 1,
wherein the method is determined in conjunction with a setting pertaining to an installation location of the communication apparatus.

17. The communication apparatus according to claim 1,
wherein a confirmation screen is displayed for causing a user to confirm whether to allow a connection through the wireless communication between the communication apparatus and the external apparatus, in a case where a request for sharing the parameter using Wi-Fi Protected Setup is received from the external apparatus in a state in which a method using one of a code image, a button, NFC, or Bluetooth is selected by the selection unit, and
the control unit is configured to control processing for sharing the parameter between the communication apparatus and the external apparatus to be executed in a case where an operation for allowing the connection using the wireless communication is accepted in the confirmation screen.

18. The communication apparatus according to claim 17,
wherein displaying the confirmation screen is skipped in a case where a request for sharing the parameter using Wi-Fi Protected Setup is received from the external apparatus in a state in which the method that does not involve a user operation between the communication apparatus and the external apparatus is selected by the selection unit from the plurality of methods, and
the control unit is configured to control processing for sharing the parameter between the communication apparatus and the external apparatus to be executed.

19. The communication apparatus according to claim 1,
wherein the wireless communication is communication based on a Wi-Fi Direct standard, and
in the wireless communication, transmission of a parameter set to the external apparatus and reception of a parameter set from the external apparatus, performed as sharing of the parameter, are communication performed before processing related to which of the communication apparatus and the external apparatus is to serve as a parent device.

20. The communication apparatus according to claim 1,
wherein the wireless communication is communication based on a Wi-Fi Direct standard, and is communication capable of communicating using a 6 GHz band.

21. A control method for a communication apparatus, the control method executed by the communication apparatus, the control method comprising:
executing wireless communication in which the communication apparatus and an external apparatus communicate by wireless LAN without going through an external access point;
selecting, from a plurality of methods, a method for the communication apparatus and the external apparatus to share a parameter used by the communication apparatus and the external apparatus to connect through the wireless communication, in accordance with a user operation; and
controlling processing for sharing the parameter between the communication apparatus and the external apparatus to be executed using the method selected,
wherein the controlling includes controlling mutual authentication to be performed between the communication apparatus and the external apparatus after the processing for sharing the parameter using the selected method is performed.

22. A non-transitory computer-readable storage medium that stores one or more programs including instructions, which when executed by one or more processors of a communication apparatus, cause the communication apparatus to:
execute wireless communication in which the communication apparatus and an external apparatus communicate by wireless LAN without going through an external access point;
select, from a plurality of methods, a method for the communication apparatus and the external apparatus to share a parameter used by the communication apparatus and the external apparatus to connect through the wireless communication, in accordance with a user operation; and
control processing for sharing the parameter between the communication apparatus and the external apparatus to be executed using the method selected,
wherein in the control, mutual authentication is controlled to be performed between the communication apparatus and the external apparatus after the processing for sharing the parameter using the method selected by the selection unit is performed.
